(19) United States
(12) Patent Application Publication
(10) Pub. No.: US 2018/0357121 A1
(43) Pub. Date: Dec. 13, 2018

(54) ERROR CORRECTION CALCULATION UPON SERIAL BUS ABORT

(71) Applicant: QUALCOMM Incorporated, San Diego, CA (US)

(72) Inventors: Sharon GRAIF, Zichron Yakov (IL); Tomer Rafael BEN-CHEN, Amikam (IL); Samer TOBIA, Shefaraam (IL)

(21) Appl. No.: 15/992,701

(22) Filed: May 30, 2018

Related U.S. Application Data
(60) Provisional application No. 62/517,696, filed on Jun. 9, 2017.

(51) Int. Cl. G06F 11/07; G06F 13/42; G06F 11/10

(52) U.S. Cl. CPC G06F 11/0793; G06F 11/1004; G06F 13/4282; G06F 11/0745

(57) ABSTRACT

Systems, methods, and apparatus are described that enable communication of signals over a serial data bus. A method performed at a transmitter/sender device coupled to the serial data bus includes determining at a transmitter on the serial data bus a condition whereby a receiver in communication with the transmitter on the serial data bus is initiating a termination of data transfer between the transmitter and the receiver. The method further includes calculating an error check word in the transmitter simultaneous with data transfer from the transmitter to the receiver, and temporarily taking control of the serial bus with the transmitter after initiation of the termination of data transfer and transmitting the calculated error check word to the receiver.

### PRIORITY CLAIM

This application claims priority to and the benefit of Provisional Patent Application No. 62/517,696, filed in the United States Patent and Trademark Office on Jun. 9, 2017, the entire content of which is incorporated herein by reference as if fully set forth below in its entirety and for all applicable purposes.

### TECHNICAL FIELD

The present disclosure relates generally to an interface between processing circuits and peripheral devices and, more particularly, to providing an error correction calculation, such as a cyclic redundancy check (CRC) calculation, upon the occurrence of a serial bus abort.

### INTRODUCTION

Mobile communication devices include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derive certain implementation aspects from the I2C protocol. The I3C bus protocols are defined by the Mobile Industry Processor Interface Alliance (MIPI). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. Other protocols, such as the I3C protocol, can increase available bandwidth on the serial bus through higher transmitter clock rates, by encoding data in signaling state of two or more wires, and through other encoding techniques. Certain aspects of the I3C protocol are derived from corresponding aspects of the I2C protocol, and the I2C and I3C protocols can coexist on the same serial bus.

In some conventional serial buses, a receiver cannot signal the sender to stop transmission while the sender is actively driving the wires of the serial bus during data transfers. In known modes of the MIPI defined I3C standards, as one example, high data rate (HDR) transfer uses the traditional two-wire data transfer, where one line (SCL) is used by a Master to provide the clock and the other (SDA) is used by either the Master (for WRITE to Slave) or by the Slave (for READ from the Slave) to carry the data. The MIPI I3C standard includes a provision that allows a receiver of data to terminate or abort a transfer and take control of the bus. In particular, when a physical data line is driven actively by the transmitter of data, a receiver can abort the READ by taking over the data line while the transmitter is sending data (e.g., preamble bits in the particular instance of MIPI I3C) for any of a number of various reasons. In such cases, however, the data is not protected by a cyclic redundancy check (CRC) word as the CRC word is typically not yet transmitted, and therefore the data already transferred prior to the abort has reduced reliability without such error check. In many cases, however, the data received prior to the abort is useful, and thus provision of a CRC in such situations may be useful to protect against errors in order to, in turn, be able to effectively use the partially received data. Accordingly, there is need to provide a CRC word or other similar error protection in at least cases of an aborted transfer to allow use of data transferred prior to an abort by a receiver device in serial busses.

### SUMMARY

Certain aspects of the disclosure relate to systems, apparatus, methods and techniques that provide a CRC mechanism that can be used on a multi-wire serial bus including an I3C bus that is operated in a double data rate (DDR) mode of operation.

According to an aspect, a method for communication in a serial data bus, is disclosed. The method includes determining, at a sending device on the serial data bus, a condition whereby a receiver in communication with the sending device over the serial data bus is initiating a termination of data transfer between the sending device and the receiver.

Further, the method includes calculating an error check word in the sending device simultaneous with data transfer from the sending device to the receiver. Additionally, the method includes taking control of the serial bus with the sending device after initiation of the termination of data transfer and transmitting the calculated error check word from the sending device to the receiver.

According to another aspect, the present disclosure provides an apparatus that includes a first line driver coupled to a first wire of a multi-wire serial bus, a second line driver coupled to a second wire of the multi-wire serial bus, and an interface controller. The interface controller is configured to determine a condition whereby a receiver in communication with the apparatus on the multi-wire serial bus is initiating a termination of data transfer between the apparatus and the receiver. The interface controller is also configured to calculate an error check word simultaneous with data transfer from the apparatus to the receiver, and to take control of the multi-wire serial bus with the apparatus after initiation of the termination of data transfer by the receiver, and then further transmit the calculated error check word to the receiver.

In yet another disclosed aspect, an apparatus for communication in a serial data bus is described including means for determining at a sending device on the serial data bus a condition whereby a receiver in communication with the sending device on the serial data bus is initiating a termination of data transfer between the sending device and the receiver. The apparatus further includes means for calculating an error check word in the sending device simultaneous with data transfer from the sending device to the receiver. Also, the apparatus includes means for taking control of the serial bus with the sending device after initiation of the termination of data transfer and transmitting the calculated error check word to the receiver.

In still another aspect, a processor readable, non-transitory storage medium is disclosed. The medium includes code for determining, at a sending device on a serial data bus, a condition whereby a receiver in communication with the sending device over the serial data bus is initiating a termination of data transfer between the sending device and the receiver. The medium further includes code for calculating an error check word in the sending device simultaneous with data transfer from the sending device to the receiver. Additionally, the medium includes code for affording taking control of the serial bus with the sending device after initiation of the termination of data transfer, and transmitting the calculated error check word from the sending device to the receiver.

A method performed at a receiving device coupled to a serial bus, comprising: receiving data over the serial bus from a sending device; initiating a termination of data transfer from the sending device prior to completion of data transfer from the sending device; and receiving a calculated error check word from the sending device on the serial bus after initiating the termination of data transfer by the receiver.

### BRIEF DESCRIPTION OF THE DRAWINGS

FIG. 1 illustrates an apparatus employing a data link between IC devices that is selectively operated according to one of plurality of available standards.

FIG. 2 illustrates a communication link in which a configuration of devices are connected using a serial bus.

FIG. 3 illustrates certain aspects of an apparatus that includes multiple devices connected to a serial bus.

FIG. 4 includes a timing diagram that illustrates signaling on a serial bus when the serial bus is operated in a single data rate (SDR) mode of operation defined by I3C specifications.

FIG. 5 is a timing diagram 500 that illustrates an example of a transmission in an I3C high data rate (HDR) mode, where data is transmitted at double data rate (DDR).

FIG. 6 illustrates an example of signaling transmitted on the SDA wire and SCL wire of a serial bus to initiate certain mode changes.

FIG. 7 illustrates a state diagram of states during HDR mode in an I3C bus according to aspects of the present disclosure.

FIG. 8 is a table illustrating data within an exemplary CRC′ word according to aspect of the present disclosure.

FIG. 9 is a block diagram illustrating an example of an apparatus employing a processing circuit that may be adapted according to certain aspects disclosed herein.

FIG. 10 illustrates an example of line driving circuits that may be used to provide hardware flow control in accordance with certain aspects disclosed herein.

FIGS. 11-18 provide timing diagrams that illustrate examples of bus flow-control in accordance with certain aspects disclosed herein.

FIG. 19 is a block diagram illustrating an example of an apparatus employing a processing circuit that may be adapted according to certain aspects disclosed herein.

FIG. 20 is a flowchart illustrating a flow-control process that may be performed at a sending or transmitting device coupled to a serial bus in accordance with certain aspects disclosed herein.

FIG. 21 illustrates a hardware implementation for a sending or transmitting apparatus in accordance with certain aspects disclosed herein.

FIG. 22 is a flowchart illustrating a flow-control process that may be performed at a receiving device coupled to a serial bus in accordance with certain aspects disclosed herein.

FIG. 23 illustrates a hardware implementation for a receiving apparatus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the present disclosure will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

The presently disclosed methods and apparatus relate to serial bus interfaces where a receiver has the capability to terminate or abort a data transfer by taking over an SDA line while a sender is sending data (e.g., preamble bits). In many cases, the data received prior to the transaction termination is useful, such as when the receiver is running out of buffers or has higher priority tasks to perform. Because the sender does not send a CRC word for the aborted transaction, the receiver cannot reliably use the data and/or take advantage of the additional protection that a CRC word can provide. Accordingly, the present methods, apparatus, and systems provide the ability for a sender device to calculate a CRC word contemporaneously or “on the fly” with an abort. In particular, when a sender detects a transaction-abort condition, the sender will send a CRC word rather than continue to other procedures, such as HDR Restart/exit patterns in the example of MIPI I3C busses.

Overview

Devices that include multiple SoC and other IC devices often employ a serial bus to connect application processor or other host device with modems and other peripherals. The serial bus may be operated in accordance with specifications and protocols defined by a standards body. The serial bus may be operated in accordance with a standard or protocol such as the I2C, I3C, serial low-power inter-chip media bus (SLIMbus), system management bus (SMB), radio frequency front-end (RFFE) protocols that define timing relationships between signals and transmissions. Certain aspects disclosed herein relate to systems, apparatus, methods and techniques that provide a flow control mechanism that can be used on an I3C bus that is operated in a DDR mode of operation.

For example, a method performed at a transmitting device coupled to a serial bus includes transmitting first data over the serial bus while the serial bus is configured for a DDR mode of operation, transmitting one or more preamble bits preceding second data transmitted on the serial bus, disabling a driver coupled to a first wire of the serial bus while transmitting the one or more preamble bits and while the first wire is in a first signaling state, terminating data transmission over the serial bus when the first wire of the serial bus has transitioned from the first signaling state to a second signaling state while the one or more preamble bits are being transmitted, and transmitting second data over the serial bus after transmitting the one or more preamble bits when the first wire of the serial bus has remained in the first signaling state during transmission of the one or more preamble bits.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar devices.

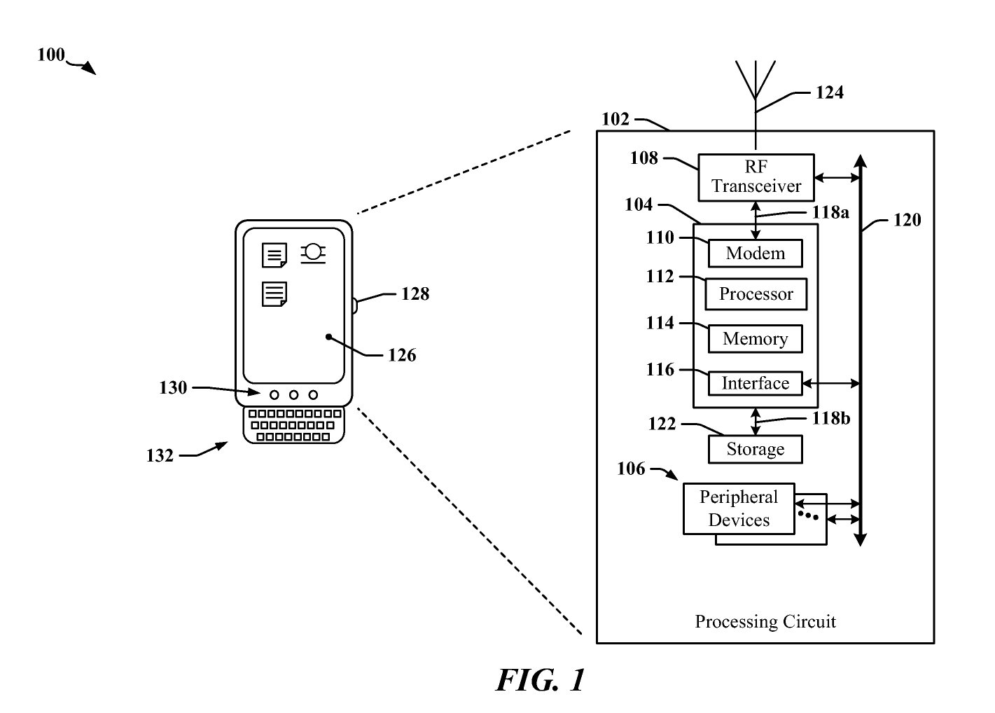

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

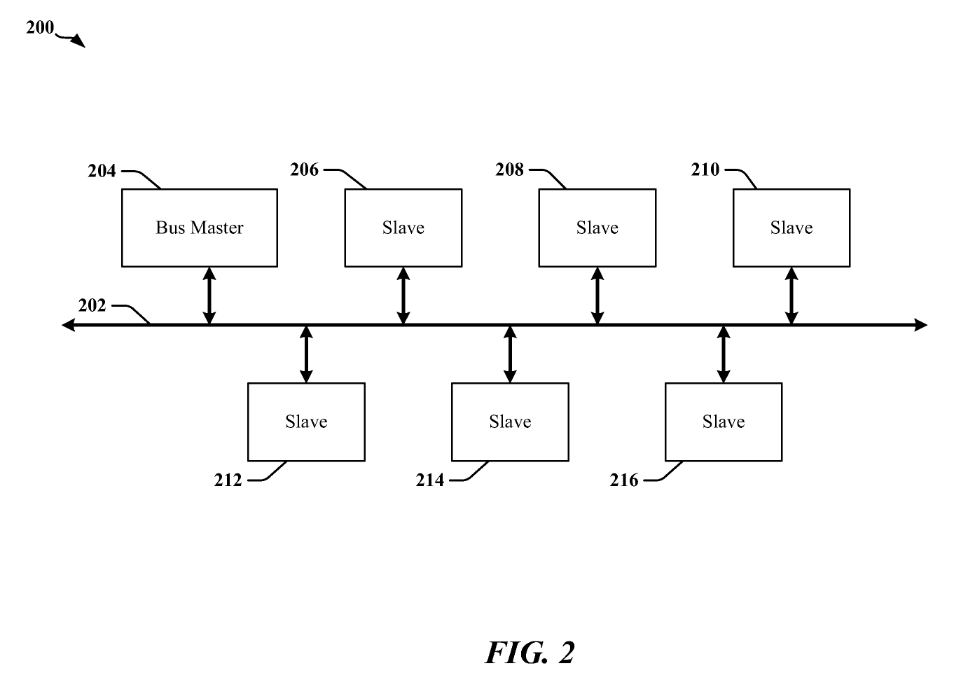

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

A master device 204 may control communication over the serial bus 202. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

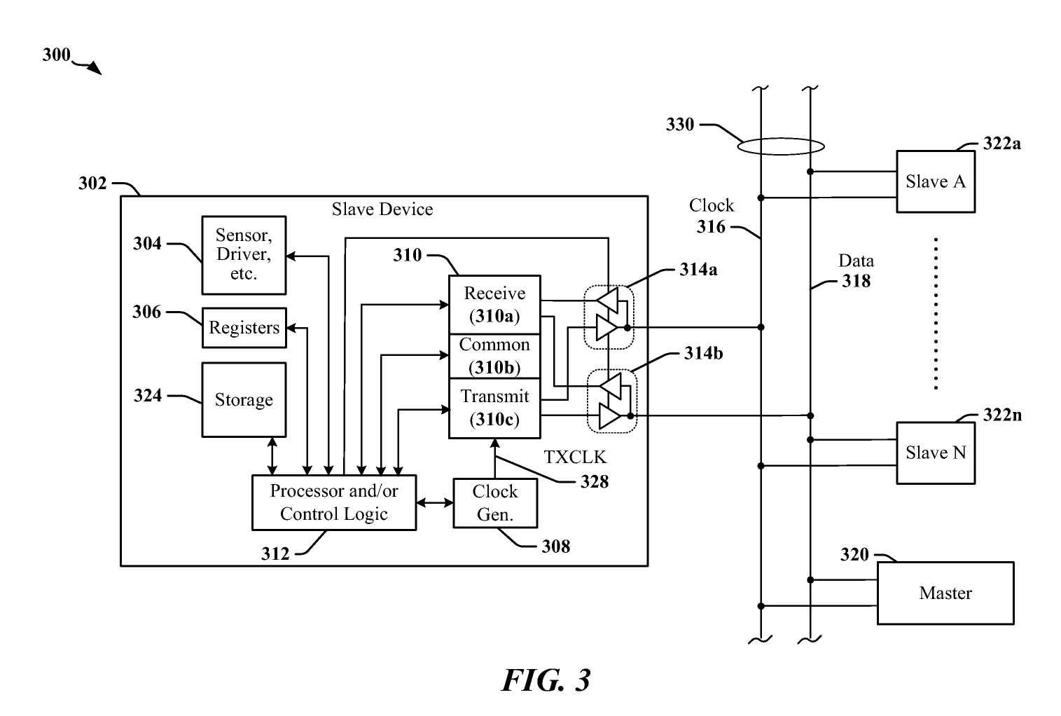

FIG. 3 illustrates certain aspects of an apparatus 300 that includes multiple devices 302, 320 and 322a-322n connected to a serial bus 330. The serial bus 330 may include a first wire 316 that carries a clock signal in certain modes of operation while a second wire 318 carries a data signal. In other modes of operation, data may be encoded in multi-bit symbols, where each bit of the symbol controls signaling state of one of the wires 316, 318. The devices 302, 320 and 322a-322n may include one or more semiconductor IC devices, such as an applications processor, SoC or ASIC. Each of the devices 302, 320 and 322a-322n may include, support or operate as a modem, a signal processing device, a display driver, a camera, a user interface, a sensor, a sensor controller, a media player, a transceiver, and/or other such components or devices. Communications between devices 302, 320 and 322a-322n over the serial bus 330 is controlled by a bus master 320. Certain types of bus can support multiple bus masters 320.

The apparatus 300 may include multiple devices 302, 320 and 322a-322n that communicate when the serial bus 330 is operated in accordance with I2C, I3C or other protocols. At least one device 302, 322a-322n may be configured to operate as a slave device on the serial bus 330. In one example, a slave device 302 may be adapted to provide a sensor control function 304. The sensor control function 304 may include circuits and modules that support an image sensor, and/or circuits and modules that control and communicate with one or more sensors that measure environmental conditions. The slave device 302 may include configuration registers 306 or other storage 324, control logic 312, a transceiver 310 and line drivers/receivers 314a and 314b. The control logic 312 may include a processing circuit such as a state machine, sequencer, signal processor or general-purpose processor. The transceiver 310 may include a receiver 310a, a transmitter 310c and common circuits 310b, including timing, logic and storage circuits and/or devices. In one example, the transmitter 310c encodes and transmits data based on timing provided by a clock generation circuit 308.

Two or more of the devices 302, 320 and/or 322a-322n may be adapted according to certain aspects and features disclosed herein to support a plurality of different communication protocols over a common bus, which may include an SMBus protocol, an SPI protocol, an I2C protocol, and/or an I3C protocol. In some examples, devices that communicate using one protocol (e.g., an I2C protocol) can coexist on the same serial bus with devices that communicate using a second protocol (e.g., an I3C protocol). In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 3-wire serial bus 330, in addition to data formats and aspects of bus control. In some aspects, the I2C and I3C protocols may define direct current (DC) characteristics affecting certain signal levels associated with the serial bus 330, and/or alternating current (AC) characteristics affecting certain timing aspects of signals transmitted on the serial bus 330.

High-Speed Data Transfers Over an I3C Serial Bus

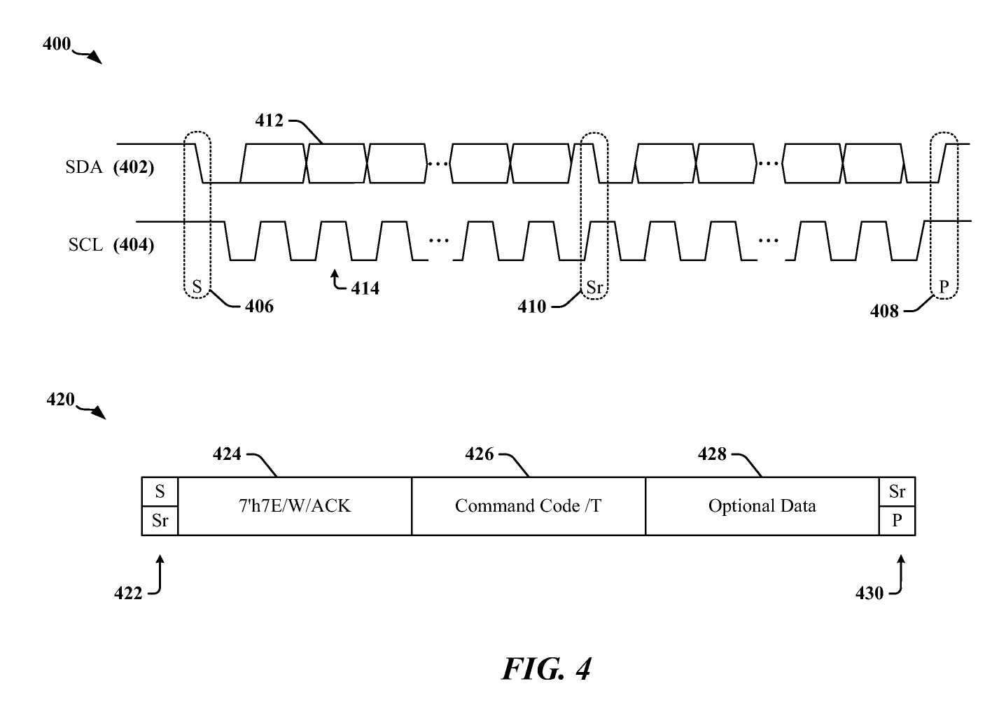

FIG. 4 includes a timing diagram 400 that illustrates signaling on a serial bus when the serial bus is operated in a single data rate (SDR) mode of operation defined by I3C specifications. Data transmitted on a first wire (the SDA wire 402) of the serial bus may be captured using a clock signal transmitted on a second wire (the SCL wire or clock line 404) of the serial bus. During data transmission, the signaling state 412 of the SDA wire 4 is expected to remain constant for the duration of the pulses 414 when the SCL wire 404 is at a high voltage level. Transitions on the SDA wire 402 when the SCL wire 404 is at the high voltage level indicate a START condition 406, a STOP condition 408 or a repeated START 410.

On an I3C serial bus, a START condition 406 is defined to permit the current bus master to signal that data is to be transmitted. The START condition 406 occurs when the SDA wire 402 transitions from high to low while the SCL wire 404 is high. The bus master may signal completion and/or termination of a transmission using a STOP condition 408. The STOP condition 408 is indicated when the SDA wire 402 transitions from low to high while the SCL wire 404 is high. A repeated START 410 may be transmitted by a bus master that wishes to initiate a second transmission upon completion of a first transmission. The repeated START 410 is transmitted instead of, and has the significance of a STOP condition 408 followed immediately by a START condition 406. The repeated START 410 occurs when the SDA wire 402 transitions from high to low while the SCL wire 404 is high.

The bus master may transmit an initiator 422 that may be a START condition 406 or a repeated START 410 prior to transmitting an address of a slave, a command, and/or data. FIG. 4 illustrates a command code transmission 420 by the bus master. The initiator 422 may be followed in transmission by a predefined command 424 indicating that a command code 426 is to follow. The command code 426 may cause the serial bus to transition to a desired mode of operation, for example. In some instances, data 428 may be transmitted. The command code transmission 420 may be followed by a terminator 430 that may be a STOP condition 408 or a repeated START 410.

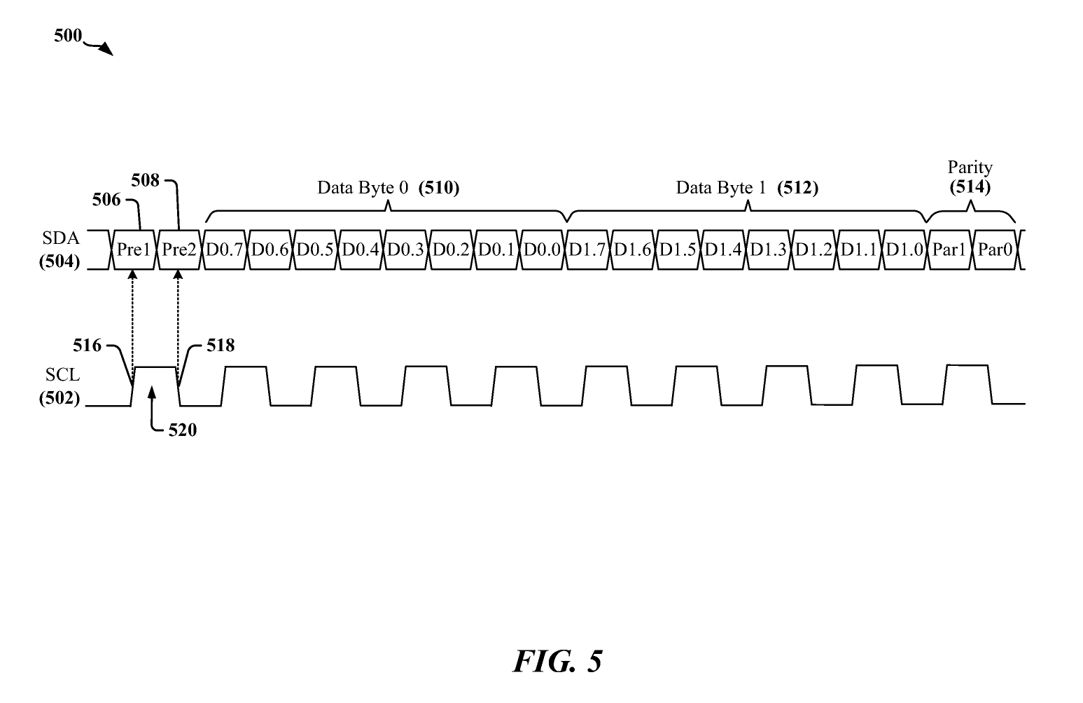

Certain serial bus interfaces support signaling schemes that provide higher data rates. In one example, I3C specifications define multiple high data rate (HDR), including a high data rate, double data rate (HDR-DDR) mode in which data is transferred at both the rising edge and the falling edge of the clock signal. FIG. 5 is a timing diagram 500 that illustrates an example of a transmission in an I3C HDR-DDR mode, in which data transmitted on the SDA wire 504 is synchronized to a clock signal transmitted on the SCL wire 502. The clock signal includes pulses 520 that are defined by a rising edge 516 and a falling edge. A master device transmits the clock signal on the SCL wire or clock line 502, regardless of the direction of flow of data over the serial bus. A transmitter outputs one bit of data at each edge 516, 518 of the clock signal. A receiver captures one bit of data based on the timing of each edge 516, 518 of the clock signal.

Certain other characteristics of an I3C HDR-DDR mode transmission are illustrated in the timing diagram 500 of FIG. 5. According to certain I3C specifications, data transferred in HDR-DDR mode is organized in words. A word generally includes 16 payload bits, organized as two 8-bit bytes 510, 512, preceded by two preamble bits 506, 508 and followed by two parity bits 514, for a total of 20 bits that are transferred on the edges of 10 clock pulses. The integrity of the transmission may be protected by the transmission of the parity bits 514.

In HDR-DDR mode, the physical SDA wire 504 is driven actively by the sender of the data, and the receiver has no ability to send a request in a signal on the SDA wire 504 to cease or suspend transmissions. A request to cease or suspend transmission may be desirable to implement a flow-control capability for the serial link Absent the availability of flow-control, the receiver must absorb all transmitted data, irrespective of the ability of the receiver to process, store or forward the data. In some instances, flow-control techniques may be useful or desirable when memory space of the receiver has been exhausted, the transfer delivers data too quickly, or the receiver is busy or burdened handling other tasks, etc.

In some implementations of the I3C standards, the I3C HDR-DDR protocol supports flow-control for read procedures, where a slave device is transferring data to a bus master device. Flow-control for a read procedure enables the master device to terminate a read transaction. According to certain aspects disclosed herein, devices coupled to a serial bus may be adapted to provide flow-control for I3C HDR-DDR write procedures, where the master device or a peer slave device is transmitting data to the slave device. Flow-control procedures implemented for I3C HDR-DDR write procedures enable a slave device to signal a request to the master device to terminate a write transaction.

According to certain aspects disclosed herein, a slave device may request the master device to terminate a write transaction by manipulating one or more preamble bits 506, 508. By manipulating the preamble bits, the ending of the data transfer can be safely achieved. In some instances, a master device may assume control of the serial bus and terminate the current transaction in response to the request to terminate write transaction. In other instances, the sender can either continue the data transfer. Termination or continuation of a transaction may depend on the type of transaction. In one example, depending on the SDA transitions, the sending device can either continue the data transfer or the master device may initiate termination of a transaction, take over the transaction, and provide either an HDR Restart or an EXIT pattern.

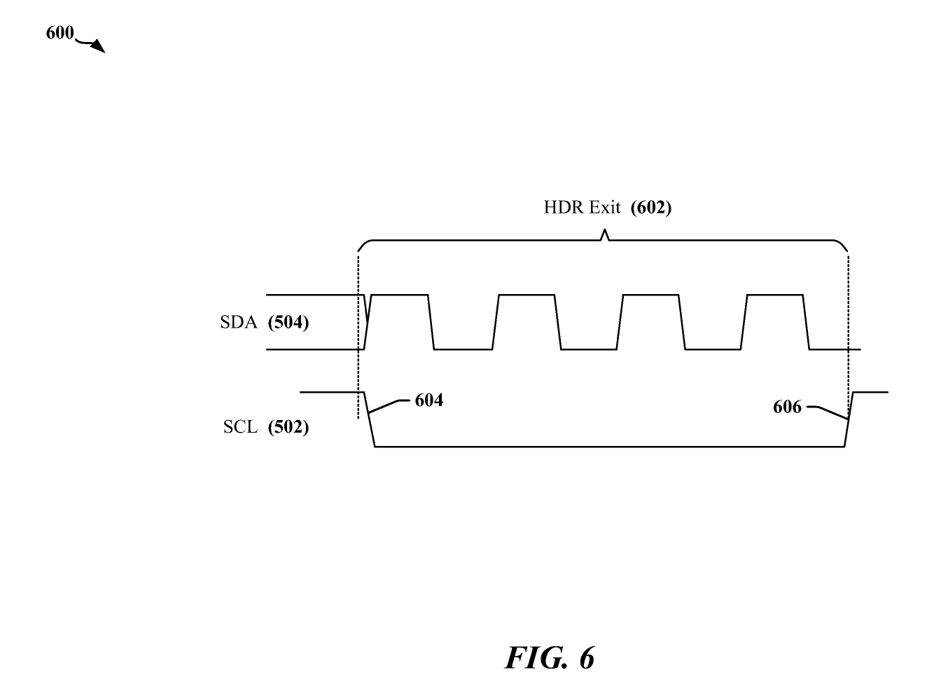

FIG. 6 illustrates an example of signaling 600 transmitted on the SDA wire 504 and SCL wire 502 to initiate certain mode changes. The signaling 600 is defined by I3C protocols for use in initiating restart, exit and/or break from I3C HDR modes of communication. The signaling 600 includes an HDR Exit 602 that may be used to cause an HDR break or exit. The HDR Exit 602 commences with a falling edge 604 on the SCL wire 502 and ends with a rising edge 606 on the SCL wire 502. While the SCL wire 502 is in low signaling state, four pulses are transmitted on the SDA wire 504. I2C devices ignore the SDA wire 504 when no pulses are provided on the SCL wire 502.

Flow Control and Error Correction Calculation for Serial Bus Communication Termination

Of initial note, the various examples discussed herein may be based on or refer to a MIPI-defined I3C bus, and to the HDR-DDR mode. The use of MIPI I3C HDR-DDR mode and other I3C modes are referenced as examples only, and the principles disclosed herein are applicable in other contexts. That is, those skilled in the art will appreciate that the methodology may be applied to other modes within I3C, I2C, or even to other serial bus communications where the pertinent functionalities might be employed. Additionally, certain aspects disclosed herein provide circuits and techniques by which a receiver can request the sender to terminate or suspend data transfer. The disclosed circuits and techniques may be employed to implement a flow control mechanism when all physical lines are being driven by the sender.

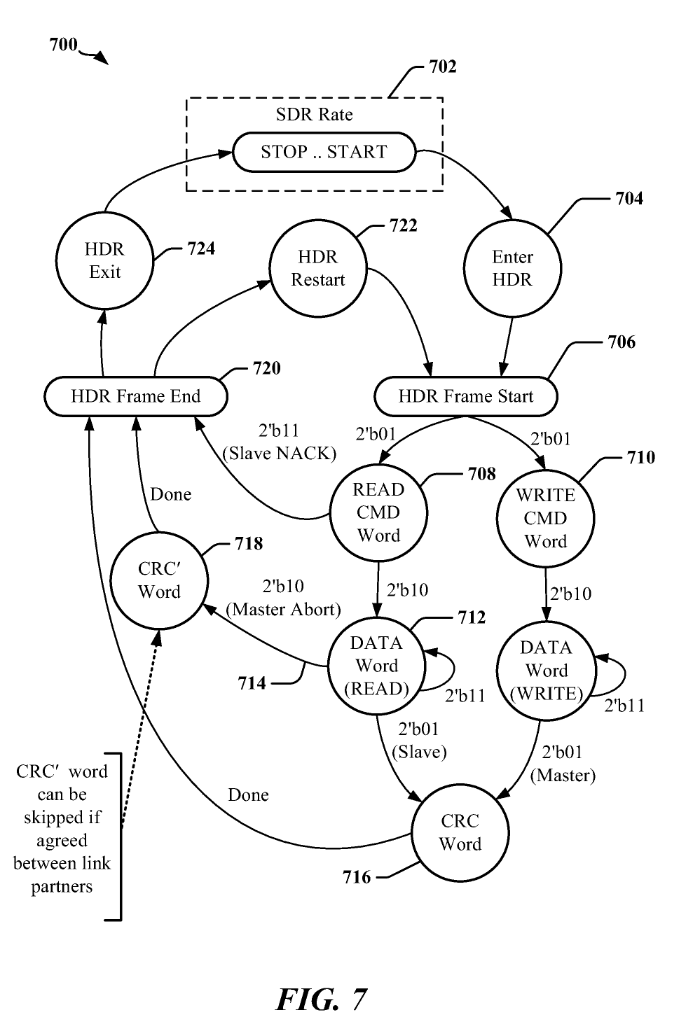

FIG. 7 illustrates a state diagram of states during HDR-DDR mode in an I3C bus according to aspects of the present disclosure. As may be seen in FIG. 7, after the devices on an I3C bus enter HDR-DDR mode at state 702 and an HDR frame starts to be transmitted as illustrated by states 704, 706, 708, and 710, the receiving device (e.g., a Master device or the device controlling the SCL line), might initiate termination or abort of data transmission as illustrated at Data Word (Read) state 712 and state to state path 714. Thus, the path from state 712 will be changed from a complete data transfer state (See e.g., CRC transfer state 716) to a state where a CRC word (e.g., CRC′ word) is sent after the completion as shown at state 718. In the present case, the state changes from state 712 to state 718 where a CRC′ word is sent in lieu of the typical or normal CRC word (i.e., state 716). As will be explained in further detail below, the CRC′ word is a word calculated contemporaneously at the transmitter/sender device with the transmission of the data (i.e., “on the fly”) and based on the transmitted data such that when a receiver aborts transmission, the CRC′ word may be sent by the transmitter/sender device to the receiver device. It is noted that according to other aspects, the CRC′ word may be derived through other means such as a lookup table, for example, but calculation performed on the fly is a more straightforward and simpler implementation for deriving the CRC′ word.

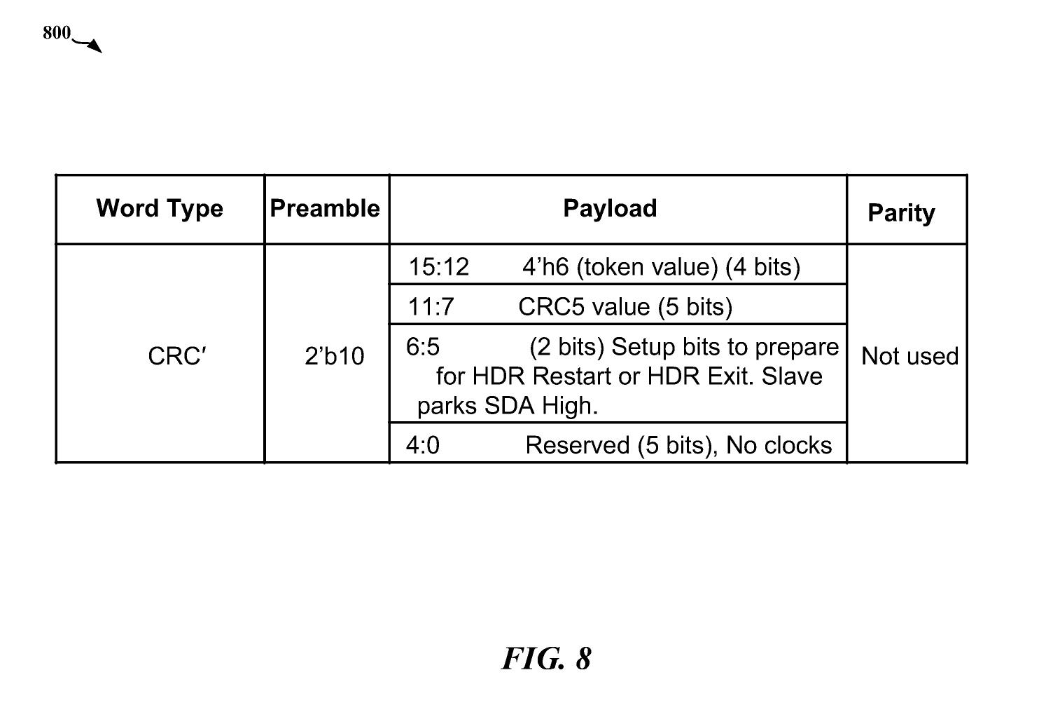

It is further noted that when a Transmitter/Sender device detects the READ-abort condition as shown at state change 714, the device will send a CRC′ word at state 718 rather than simply continue directly to the shown HDR restart/exit states (i.e., states 720) and those following such as HDR Exit 724 or HDR Restart 722. In an aspect, it is further noted that the transmitter/sender will temporarily regain control of the serial bus in order to send the CRC′ word. The time frame for regaining control, in one aspect, may be the number of SCL cycles needed to transmit all bits of the CRC′ word, which will be described further below in connection with FIG. 8. Additionally, in another aspect the sender/transmitter device is configured to switch from transmitting the DATA word to transmitting the CRC′ word within one I3C cycle to ensure that the receiver will listen to receive the CRC′ word. It is noted that the bus handover time from detecting the abort until driving the first CRC′ bit preferably is less than ½ SCL cycle in an aspect. During that time, the transmitter should stop driving the SDA line and the receiver should start driving it. However, it is also noted that the master can delay the SCL edge to increase the required time. In still a further aspect, the system may be configured such that the CRC′ word is optional, wherein the CRC′ word is sent only when agreed upon by both the transmitter/sender device and the receiver.

FIG. 8 is a table illustrating data within an exemplary CRC′ word 800 according to aspect of the present disclosure. As illustrated the CRC′ word 800 may be comprised of 18 bits, including 2 preamble bits, 4 token value bits, a CRCS value (i.e., the CRC value used for error correction), 2 setup bit the prepare for HDR Restart or HDR Exit, and 5 reserved bits. The number of bits and fields illustrated is merely exemplary, and those skilled in the art will appreciate that other variations and configuration may be envisioned that are still operable for carrying out the present methods and apparatus.

Of further note in the context of I3C HDR-DDR protocol, FIG. 8 illustrates that the preamble bits are configured differently from a standard CRC word (i.e., 2′b10 rather than 2′b01), which serves to differentiate the two types of CRC words. In a further aspect, the actual CRC′ word may start (i.e., at the token value 0110/4′h6) with a binary ‘0’ bit rather than the typical binary “1” to avoid contention with the READ-abort preamble bits. This is different from the regular CRC token, which has the binary token value 1100/4′hC, which could cause contention on SDA lines in this particular scenario. Since the CRC′ word starts with a binary ‘0’ from Sender, and the preamble ends with binary “0” from Receiver, there is no risk of contention on the SDA line when switching drivers. In a further aspect of the present invention, it is noted that when the present methodology is applied to other standards or protocols, the CRC (or error correction) word may be started with some predetermined value that will be configured to avoid or mitigate bus contention. In the case of using the original I3C CRC token of 4′hC, the master will keep driving the beginning of CRC token and the SDA bus direction will change where consecutive bits are the same (i.e., between first two bits of CRC token (2′b11) or 3-4 two bits of a CRC token (2′b00).

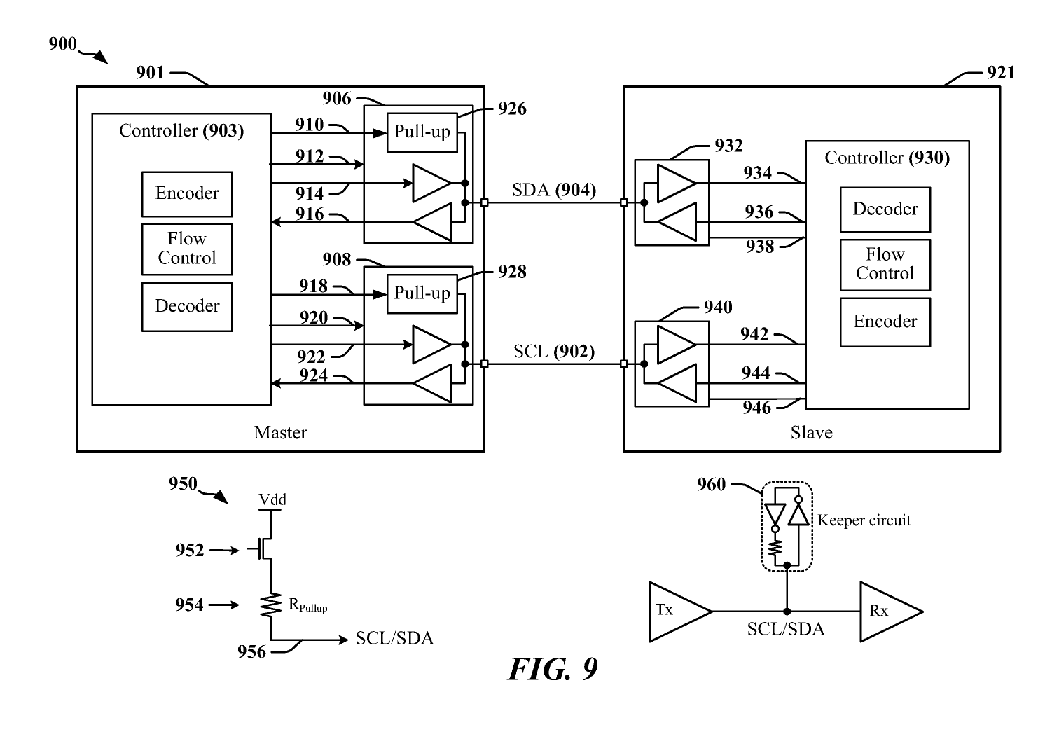

FIG. 9 illustrates an example of an I3C interface 900 that has been adapted in accordance with certain aspects disclosed herein. A master device 901 is coupled to the SCL wire 902 and SDA wire 904 of a serial interface. A slave device 921 is also coupled to the SCL wire 902 and SDA wire 904 of the serial interface. The master device 901 and the slave device 921 include respective interface controllers 903, 930 that may include encoders, decoders and flow control circuits and modules.

The master device 901 and the slave device 921 include transceivers 906, 908, 934 and 932 that may be used to transmit and receive signals over a respective wire 902, 904. The transceivers 906, 908 in the master device 901 include pull-up circuits or structures 926, 928, which may be used to emulate an open-drain pull-up coupled to the SCL wire 902 and SDA wire 904. The interface controller 903 in the master device 901 may provide a control signal 910, 918 that enables or disables the operation of corresponding pull-up circuits or structures 926, 928.

The interface controller 903 in the master device 901 may provide impedance control signals 912, 920 that can be used to place line drivers in the transceivers 906, 908 into a high-impedance mode of operation. The interface controller 903 in the master device 901 may provide a master SDA signal 914, and receive an SDA_signal 916 from the SDA wire 904. The interface controller 903 in the master device 901 may provide a master SCL signal 922 and receive an SCL_signal 924 from the SCL wire 902.

The interface controller 930 in the slave device 320 may provide impedance control signals 938, 946 that can be used to place line drivers in the transceivers 932, 934 into a high-impedance mode of operation. The interface controller 930 in the slave device 320 may provide a slave SDA signal 936, and receive an SDA_signal 934 from the SDA wire 904. The interface controller 930 in the slave device 921 may provide a slave SCL signal 942 and receive an SCL_signal 940 from the SCL wire 902.

The pull-up circuits or structures 926, 928 may be implemented using a variety of circuits. In one example, a pull-up circuit includes a pull-up resistor 954 that may be coupled to a source of high voltage (V_{DD}) through a switch 952, which may include a suitably configured transistor. In some instances, the pull-up resistor 954 may be coupled directly to V_{DD} and the switch couples the pull-up structure to the SCL wire 902 or SDA wire 904. In another example, the pull-up circuits or structures 926, 928 may be implemented using a keeper circuit 960. The keeper circuit 960 may be configured as a positive feedback circuit that drives the SCL wire 902 or SDA wire 904 through a high impedance output, and receives feedback from the SCL wire 902 or SDA wire 904 through a low impedance input. The keeper circuit 960 may be configured to maintain the last asserted voltage on the SCL wire 902 or SDA wire 904. The keeper circuit 960 can be easily overcome by line drivers in the master device 901 or slave device 921.

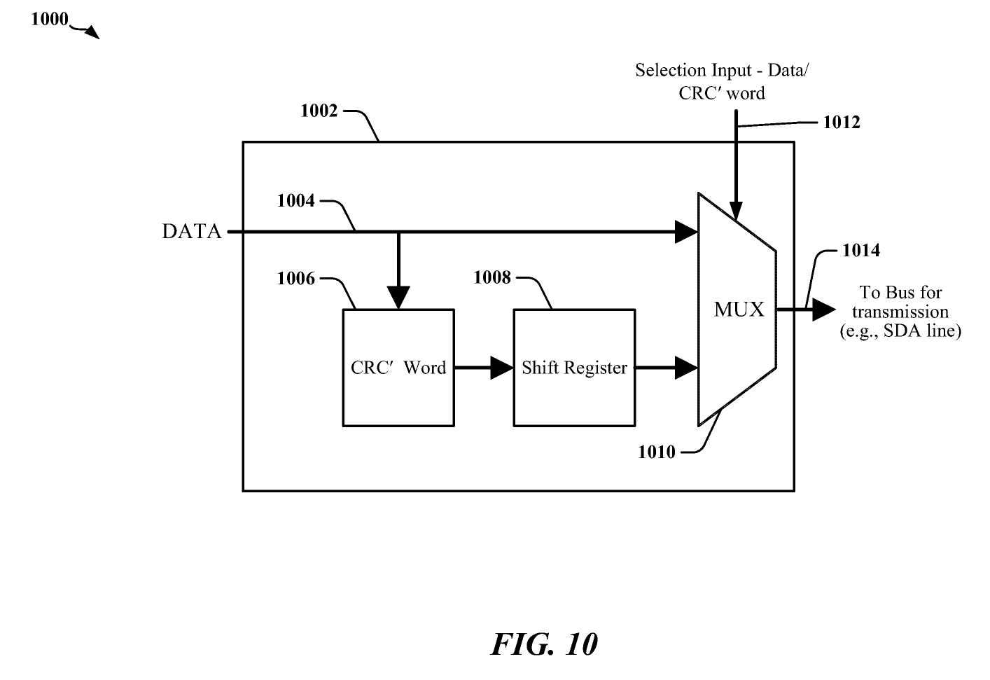

FIG. 10 illustrates an example of line driving circuits 1000 that may be used to provide hardware flow control in accordance with certain aspects disclosed herein. In particular, circuit 1002 is a circuit for use in a transmitter/sender device where circuit 1002 is configured to perform calculation of the CRC′ word, as well switch between sending data and the CRC′ word when a receiver device initiates termination or abort of data transmission. Circuit 1002 receives data 1004 for transmission. The data is input to a CRC′ word calculation circuit 1006, which affords calculation of the CRC′ word contemporaneous with data transfer, thus providing “on the fly” calculation. In an aspect, the CRC′ word calculation circuit 1006 is configured to iteratively calculate the CRCS portion of the CRC′ word iterative, where the calculation advances with every bit or two bits as they are sent on the bus. As part of this calculation, as shift register 1008 may be utilized as well. It is noted, however, that in other aspects the calculation could advance for every 1 to 16 bits as that transmission does not abort between words in normal implementations.

Both the data 1004 and the output of the combined CRC′ word calculation circuit 1006 and shift register 1008 are input to a selector switch or multiplexer 1010. As discussed before, a transmitter/sender will be configured to switch from the DATA word to the CRC′ word within less than one half (½) I3C cycle, as one example. This switching may be accomplished with multiplexer 1010 in conjunction with some logic (not shown) or controller/processor (e.g., controller 903 in FIG. 9) that provides a selection signal 1012 to quickly switch the output of multiplexer 1010 from the data 1004 to the CRC′ word for output 1014 to drive the serial data bus, and more particularly an SDA line (See e.g., transceiver 906 and SDA 904 in FIG. 9).

It is noted that since the CRC′ word calculation circuit 1006 calculates (or updates) the CRC′ word for each bit (or up to 16 bits) of data transmission, the CRCS value, which is within the CRC′ word, will always be correct. Of further note, the circuitry 1002 may be implemented within a controller (e.g., 903 or 930 in FIG. 9) or a transceiver (e.g., 906 or 932 in FIG. 9) in some examples, or even as a standalone circuit within a transmitter/sender or receiver device. Again, it is noted in an aspect that because the CRC word starts with binary ‘0’ from Transmitter/Sender, and preamble ends with binary “0” from a Receiver, there is no risk of contention on the SDA line when switching drivers.

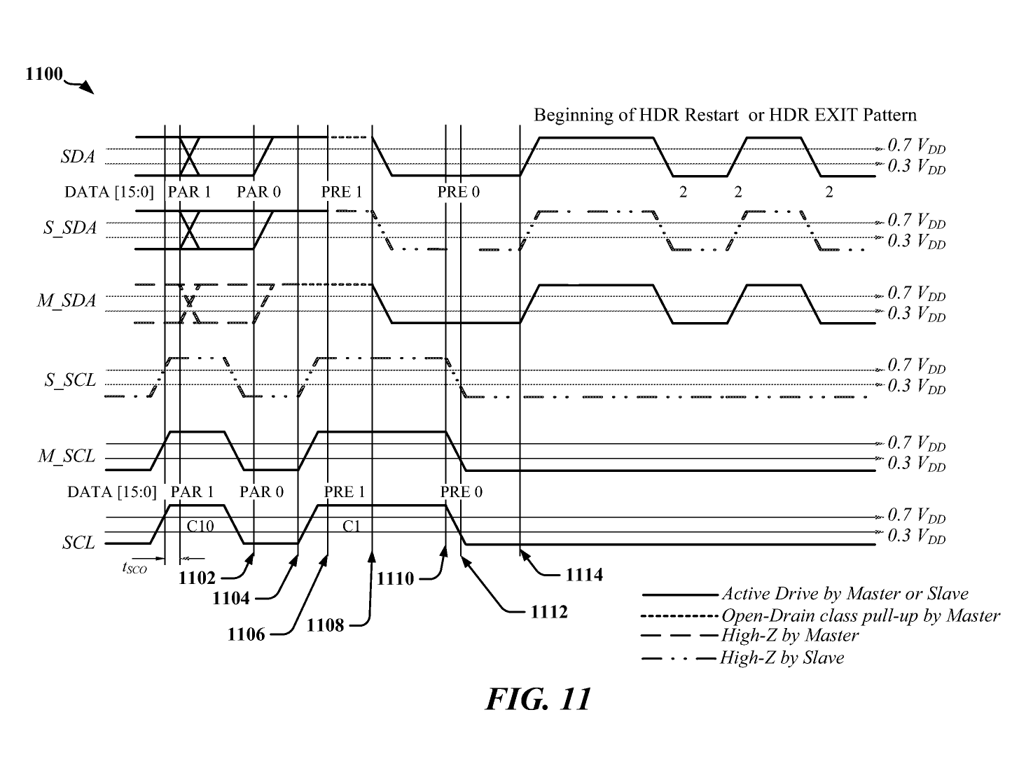

As stated above, a sending or transmitting device on the bus is configured to calculate the CRC value on the fly, which is a straightforward and simple implementation of CRC. As further described before in connection with state diagram 700 in FIG. 7, when the sending device detects a transaction-abort condition, it will send a CRC′ word rather than continue to HDR Restart/exit patterns. In an aspect, it is noted that there are several possibilities for the CRC Token (i.e., the nibble that precedes the CRC value on the CRC word). The timing of signals occurring on the SDA and SCL lines from both the perspective of the master and slave devices are illustrated in FIGS. 11-18. In these figures, two exemplary possibilities are illustrated for a master READ and a slave WRITE.

FIG. 11 illustrates an exemplary timing diagram 1100 of signals on the SDA and SCL lines according to aspects of the present invention. In the timing diagram of FIG. 11, the particular scenario illustrated is one where a master aborts or ends a READ data transfer, and no CRC word is sent or signaled. At time 1102 in the diagram 1100, after the last illustrated parity bit, PAR 0, the Slave drives the SDA line HIGH for the next Preamble bit, PRE 1, which will be 1′b1. At time 1104 in the diagram, the Master then (1) starts the SCL Rising edge of a C1 clock pulse; and (2) enables the Open-Drain class Pull-Up structure on the SDA line.

At time 1106, which is a time period longer than the time t_{SCO} past the rising edge of C1, the Slave stops the active driving of the SDA line and releases the SDA on high impedance (High-Z). At time 1108, which is after a period of time longer than t_{SCO} of the Slave, the Master starts driving the SDA line LOW. A simple way then to determine the necessary delay is to use a half cycle of the SCL clock. In an aspect, the timing could be even the full cycle to preserve the phase on the driver's logic block. The resultant SCL pulse is longer than a 50 ns timer period typically required for coexistence with Legacy I2C devices. The signal waveform may be a typical Repeated START condition, which is acceptable since in the case of a mixed bus it will be followed by an EXIT pattern and a STOP.

After another delay similar to time t_{SCO}, the Master Starts driving SCL LOW, starting the falling edge of C1 as shown at time 1110. The Slave will then have registered the SDA being driven LOW by the Master, and set the second Preamble bit, PRE0, to 1′b0. Since this condition means the end of the READ transaction, the Slave preserves the SDA line at High-Z at time 1112. Finally at time 1114, after another delay that is a period of time longer than tSCO of the Slave, the Master starts driving the SDA line HIGH, a prepares for either HDR Restart or EXIT patterns. The SCL will then be LOW and the SDA will become HIGH, being actively driven by the Master, while the Slave has both lines on High-Z. Consequently, the READ data transfer from Slave to Master has been ended.

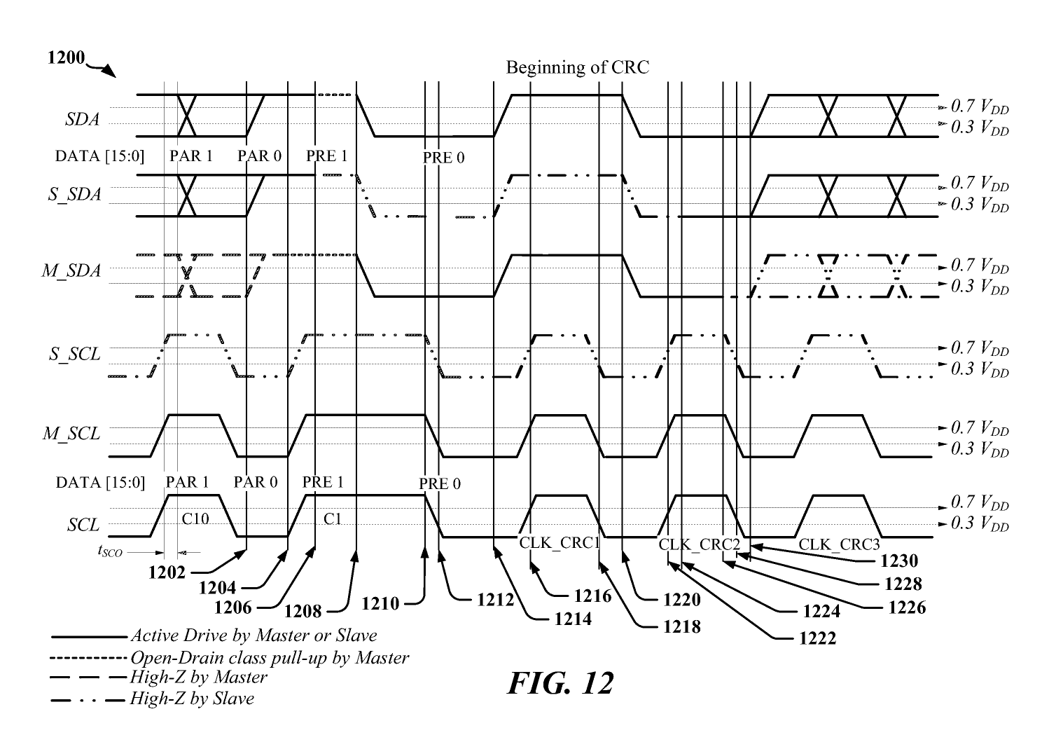

FIG. 12 is another timing diagram 1200 illustrating a scenario where a Master ends the READ data transfer, and a CRC token 4′hC is signaled. As may be seen at time 1202, after the last parity bit, PAR0, occurs, the Slave drives the SDA lines HIGH, for the next Preamble bit, PRE1, which will be 1′b1. As may be seen at time 1204, the Master then starts the SCL line rising edge of C1 clock pulse and enables the Open-Drain class Pull-Up structure on the SDA line.

At time 1206, after a time t_{SCO} past the rising edge of C1, the Slave stops the active driving of the SDA line, and releases the SDA line on High-Z. At time 1208, after a period of time longer than t_{SCO} of the Slave, the Master starts driving SDA LOW. A simple way to determine the needed delay is to use a half cycle of the SCL clock in an aspect, but this could also be even the full cycle, which will preserve the phase on the driver's logic block. The resultant SCL pulse will be longer than a 50 ns time period typically required for coexistence with Legacy I2C devices. The signal waveform is a typical Repeated START condition, which is acceptable since in the case of a mixed bus it shall be followed by an EXIT pattern and a STOP.

At time 1210, after another delay similar to that described at time 1208, the Master Starts driving the SCL line LOW, such as starting at the falling edge of C1. Next at time 1212, the Slave will then have registered the SDA being driven LOW by the Master, setting the second Preamble bit PRE0 to 1′b0. Since this condition means the end of the READ transaction, the Slave preserves the SDA line on High-Z.

At time 1214, after another delay similar to that described at time 1208, the Master starts driving the SDA line HIGH. This may be done even immediately after the falling edge of the C1, since it is under the Master's control. Next at tie 1216, the Master has provided the rising edge of the first SCL of the CRC Word (CLK_CRC1). Since the SDA was HIGH, the Slave assesses the first bit of the CRC token as 1′b1. At time 1218, at the falling edge of the word CLK_CRC1, the Slave assesses the second bit of the CRC token as 1′b1, since the SDA line was still driven HIGH by the Master.

At time 1220, the Master then drives the SDA lines LOW. At time 1222, at the rising edge of CLK_CRC2 signal, the Slave assesses the third bit of the CRC token as 1′b0, since SDA was driven LOW by the Master. Next at time 1224, after a time t_{SCO}, the Slave starts driving the SDA line LOW, in parallel with the Master; hence, there is no conflict. Both lines are driven LOW by the devices.

At time 1226, the Master then starts driving LOW the falling edge of the CLK_CRC2, and releases the SDA on High-Z. At time 1228, the Slave (and the Master) assesses the fourth bit of the CRC token as 1′b0, since the SDA line was driven LOW by the Slave. Finally, at time 1230, after time t_{SCO} the Slave starts driving the SDA lines as per the calculated CRC (e.g., CRC′ Word). The Slave will have had enough time to switch its output to the calculated CRC, as it has had almost two SCL clock times. Consequently, the Read data transfer from Slave to Master has entered the CRC based ending procedure.

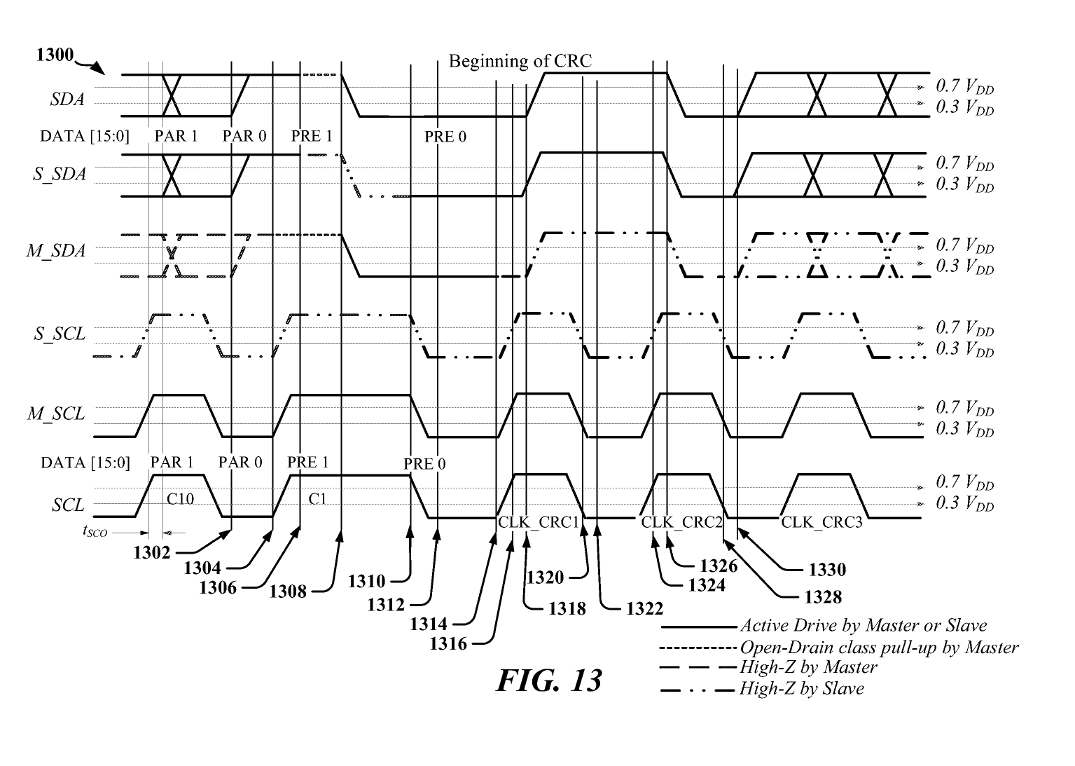

FIG. 13 illustrates a timeline of a scenario where a Master ends the READ data transfer, with the use of CRC token 4′h6 signals. As may be seen in the timeline 1300, at time 1302, after the last parity bit, PAR 0, occurs, the Slave drives the SDA lines HIGH, for the next Preamble bit, PRE 1, which will be 1′b1. As may be seen at time 1304, the Master then starts the SCL line rising edge of C1 clock pulse and enables the Open-Drain class Pull-Up structure on the SDA line.

At time 1306, after a time t_{SCO} past the rising edge of C1, the Slave stops the active driving of the SDA line, and releases the SDA line on High-Z. Moving to time 1308, after a period of time longer than t_{SCO} of the Slave, the Master starts driving SDA LOW. A simple ways to determine the needed delay is to use a half cycle of the SCL clock in an aspect, but this could also be even the full cycle, which will preserve the phase on the driver's logic block. The resultant SCL pulse will be longer than a 50 ns time period typically required for coexistence with Legacy I2C devices. The signal waveform is a typical Repeated START condition, which is acceptable since in the case of a mixed bus it shall be followed by an EXIT pattern and a STOP.

At time 1310, after another delay similar to that described at point 4, the Master Starts driving the SCL line LOW, as such starting the falling edge of C1. Next at time 1312, the Slave will then have registered the SDA being driven LOW by the Master, setting the second Preamble bit PRE0 to 1′b0. Since this condition means the end of the Read transaction, the Slave preserves the SDA line on High-Z.

At time 1314, after at least a time t_{SCO}, the Slave starts driving the SDA line LOW in parallel with the Master. Then at time 1316, the Master starts driving the rising edge of the CLK_CRC1, releases the SDA on High-Z, wherein the SDA line remains LOW, since it is driven by the Slave. At time 1318, the Master has provided the rising edge of the first SCL lines of the CRC Word, CLK_CRC1. Since the SDA was LOW, the Slave assesses the first bit of the CRC token as 1′b0.

At time 1320, after time tSCO the Slave starts driving the SDA line HIGH. Next at time 1322, at the falling edge of the CLK_CRC1 the Slave shall assess the second bit of the CRC token as 1′b1, since SDA was driven HIGH by the Slave. At time 1324, at the rising edge of CLK_CRC2, the Slave assesses the third bit of the CRC token as 1′b1, since SDA line was driven HIGH by the Slave. At time 1326, after a time t_{SCO} the Slave starts driving LOW the SDA line. At time 1328, the Slave (and the Master) assesses the fourth bit of the CRC token as 1′b0, since the SDA line was driven LOW by the Slave. Finally, at time 1330, after time tSCO the Slave starts driving the SDA lines as per the calculated CRC. Consequently, the Read data transfer from Slave to Master has entered the CRC based ending procedure.

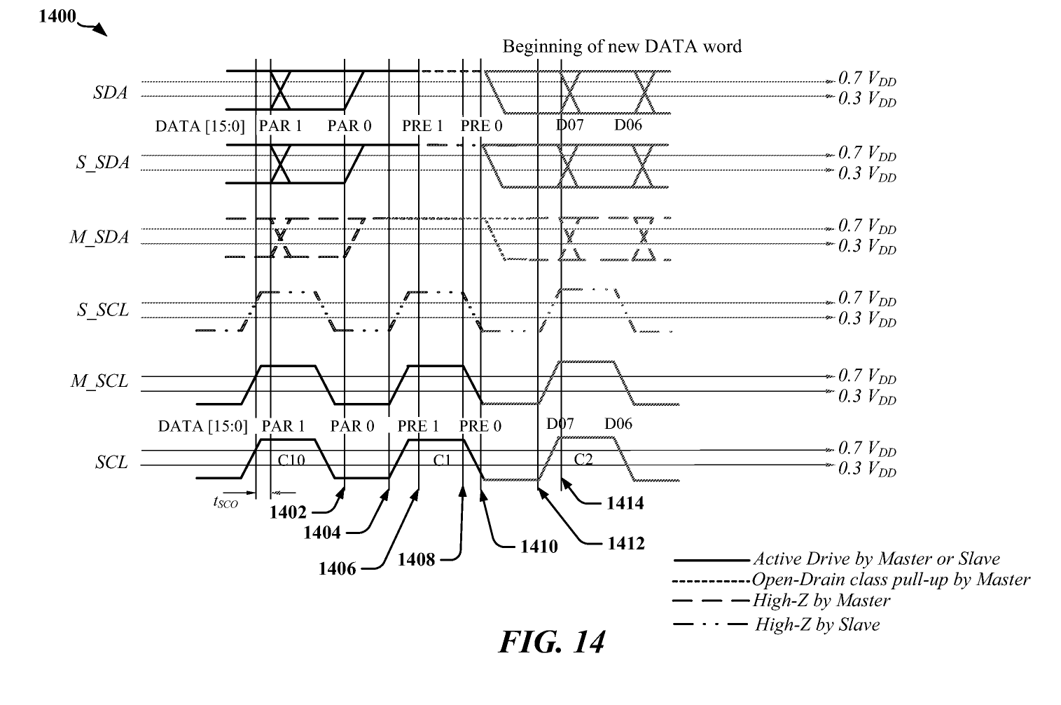

FIG. 14 illustrates a timeline scenario 1400 where a Master agrees to continue READ data transfer signals. At time 1402, after the last parity bit, PAR 0, the Slave drives the SDA line HIGH, for the next Preamble bit, PRE 1, which is 1′b1. At time 1404, the Master starts the SCL rising edge of C1 clock pulse and enables the Open-Drain class Pull-Up structure on SDA line. As shown at time 1406, after time t_{SCO} past the rising edge of C1, the Slave stops the active driving of the SDA line and releases the SDA line on High-Z. Next at time 1408, at the falling edge of C2, the Slave registers the SDA lines as being HIGH.

At time 1410, after at least a time t_{SCO}, the Slave starts actively driving the SDA line for the first bit of data payload D0.7 (See e.g., FIG. 5). At time 1412, after a suitable period, the Master disables the Open-Drain class Pull-Up structure on the SDA line, and sets its SDA on High-Z. The delay is then at least equal to Slave's t_{SCO} and there is a safe time period at the start of the rising edge of C2. Depending of the Master's design, the time period could be shorter. Finally, at time 1414, after at least a time t_{SCO}, the Slave starts driving the SDA line for the second bit of data payload, D06. Consequently, the data transfer from Slave to Master continues.

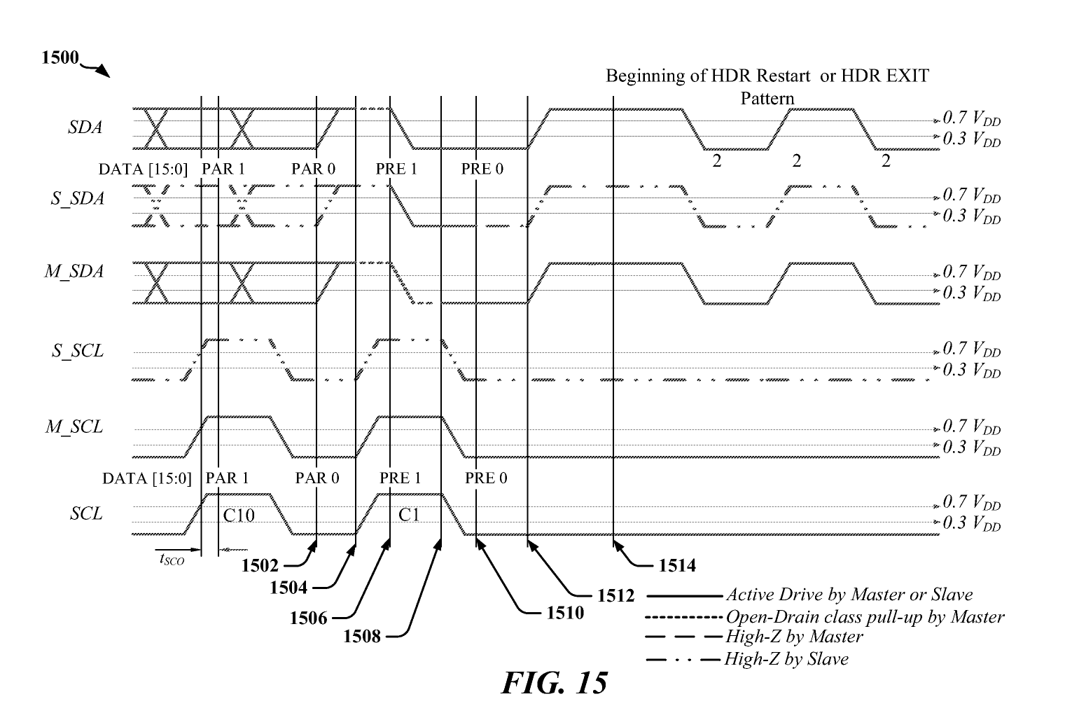

FIG. 15 illustrates a timeline 1500 of a scenario where a Slave ends WRITE data transfer with no CRC signals. As may be seen at time 1502, after a last parity bit, PAR 0, the Master drives the SDA line HIGH for the next Preamble bit, PRE 1, which is 1′b1. At time 1504, the Master starts the rising edge of C1, disables the active drive of SDA, and enables the Open-Drain class Pull-Up structure on the SDA line. After time t_{SCO} the Slave actively drives the SDA LOW as shown at time 1506.

At time 1508, the Master starts the falling edge of C1. Since the Master knows that the SDA line was pulled LOW by the Slave (i.e., PRE 0 is 1′b0), it starts driving the SDA line actively LOW, in parallel with the Slave. At time 1510, after at least a time t_{SCO}, the Slave releases its SDA line on High-Z. The Master starts actively driving the SDA line HIGH, after a suitable delay as shown in time 1512. One way to achieving the delay is to use a half of an SCL clock cycle.

At time 1514, after another delay similar to that at time 1512, the SDA line is HIGH, as having been actively driven by the Master, the SCL line is LOW, as having been actively driven by the Master, the Slave has both SCL and SDA released on High-Z, and the Master can start either HDR Restart or HDR EXIT patterns. As a consequence, the data transfer from Master to Slave has been ended.

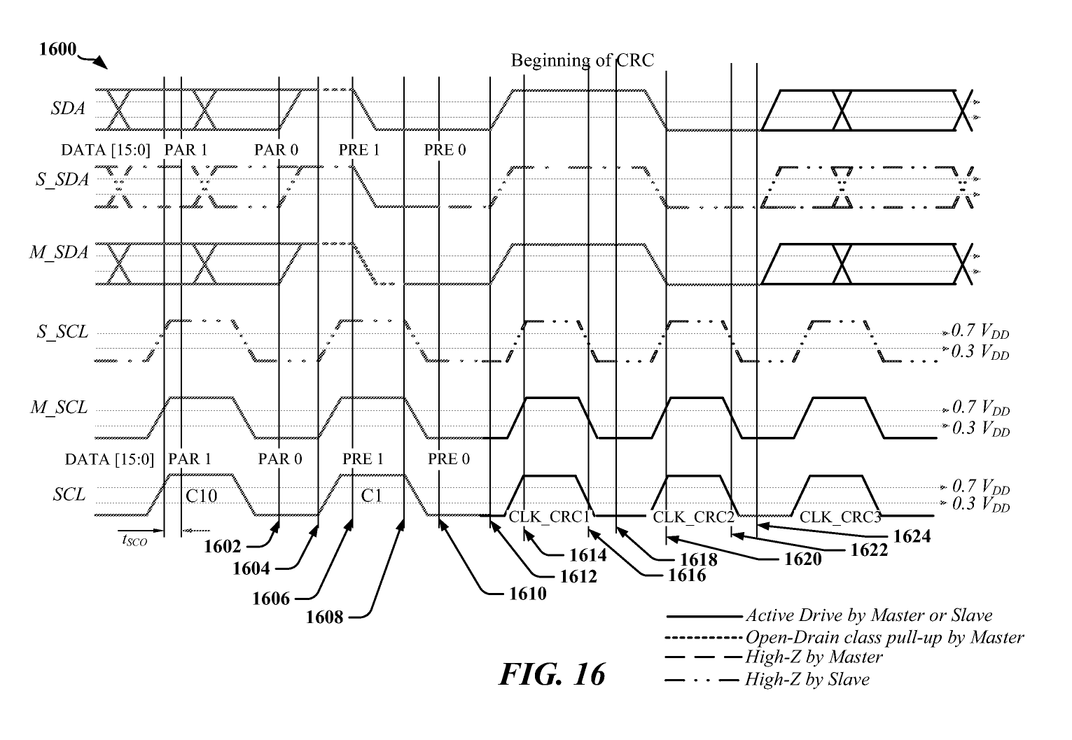

FIG. 16 illustrates a timeline 1600 showing a scenario where a Slave ends WRITE data transfer, and utilizes CRC token 4′hC signals. In timeline 1600, at time 1602 after the last parity bit, PAR 0, the Master drives the SDA line HIGH for the next Preamble bit, PRE1, which will be 1′b1. At time 1604, The Master starts the rising edge of C1, disables the active drive of SDA, and enables the Open-Drain class Pull-Up structure on the SDA line. After at least a time t_{SCO} the Slave actively drives the SDA line LOW as may be seen at time 1606.

Next at time 1608, the Master starts the falling edge of C1. Because the Master knows that the SDA line was pulled LOW by the Slave (i.e., PRE0 is 1′b0), the Master starts actively driving the SDA line LOW, in parallel with the Slave. At time 1610, after at least a time t_{SCO}, the Slave releases its SDA line on High-Z. Next at time 1612, the Master starts actively driving the SDA line HIGH, after some suitable delay. At time 1614, the Master has provided the rising edge of the first SCL of the CRC Word, CLK_CRC1. Since the SDA was HIGH, the Slave assesses the first bit of the CRC token as 1′b1.

At the falling edge of the CLK_CRC1, the Slave assesses the second bit of the CRC token as 1′b1, since SDA was still driven HIGH by the Master as shown at time 1616. At time 1618 the Master drives the SDA line LOW. At time 1620, at the rising edge of CLK_CRC2, the Slave assesses the third bit of the CRC token as 1′b0, since the SDA line was driven LOW by the Master. At the falling edge of CLK_CRC2, the Slave (and the Master) assesses the fourth bit of the CRC token as 1′b0, since the SDA was driven LOW by the Slave as shown at time 1622. Finally, at time 1624, the Master starts driving the SDA line as per the calculated CRC. Consequently, the WRITE data transfer from Master to Slave has entered the CRC based ending procedure.

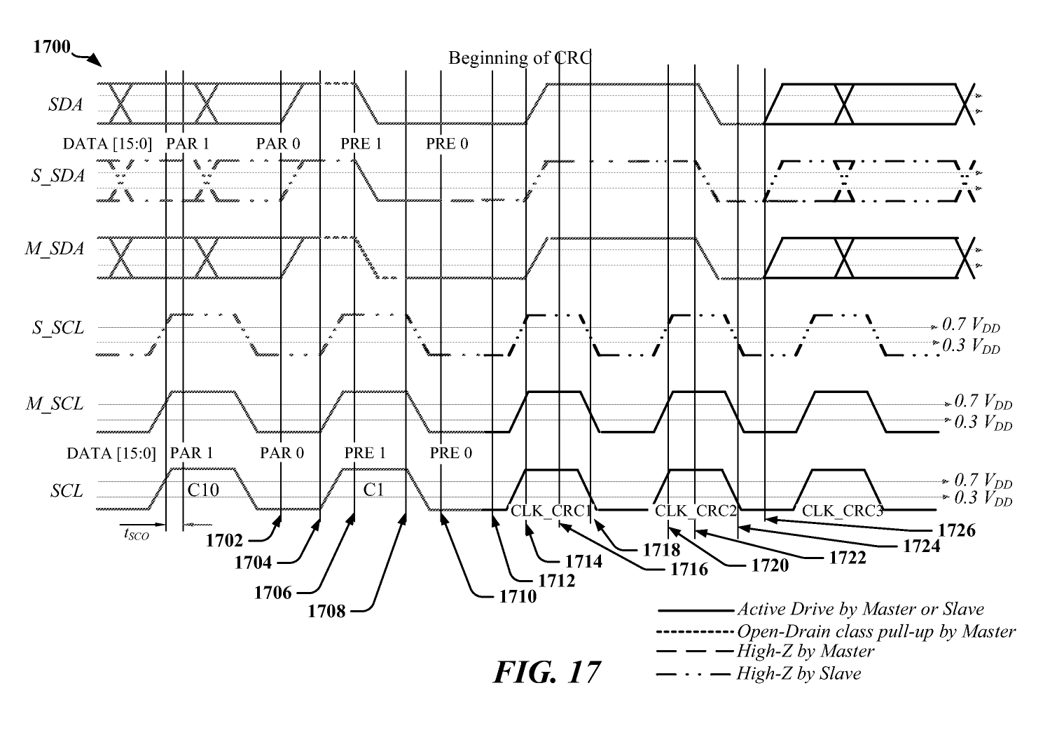

FIG. 17 illustrates a timeline 1700 for a scenario where a Slave ends WRITE data transfer, and CRC token 4′h6 is signaled. At time 1702, after the last parity bit, PAR 0, the Master drives the SDA line HIGH for the next Preamble bit, PRE 1, which is 1′b1. The Master then starts the rising edge of C1, disables the active drive of SDA, and enables the Open-Drain class Pull-Up structure on the SDA line at time 1704. At time 1706, after at least a time t_{SCO}, the Slave drives actively the SDA line LOW. The Master then starts the falling edge of C1 at time 1708 as it knows that the SDA was pulled LOW by the Slave, hence PRE 0 is 1′b0. The Master also starts actively driving the SDA line LOW, in parallel with the Slave.

After a time t_{SCO}, the Slave releases its SDA on High-Z as shown at time 1710. At time 1712, the Master keeps actively driving the SDA line LOW. At time 1714, the Master has provided the rising edge of the first SCL of the CRC Word, CLK_CRC1. Since the SDA line was LOW, the Slave assesses the first bit of the CRC token as 1′b0. At time 1716, the Master starts driving the SDA line HIGH, according to Push-Pull mode timing. At the falling edge of the CLK_CRC1 the Slave assesses the second bit of the CRC token as 1′b1, since SDA was driven HIGH by the Master as shown at time 1718. At time 1720, at the rising edge of CLK_CRC2, the Slave assesses the third bit of the CRC token as 1′b1, since SDA was driven HIGH by the Master.

Next at time 1722, the Master starts driving the SDA line LOW, as per Push-Pull mode timing. At the falling edge of CLK_CRC2, the Slave (and the Master) assesses the fourth bit of the CRC token as 1′b0, since the SDA was driven LOW by the Slave as shown at time 1724. The Master starts driving the SDA lines according to the calculated CRC word as shown at time 1726. It is noted that the Master has had enough time to switch its output to the calculated CRC, as it had almost two SCL clock times. Consequently, the WRITE data transfer from Master to Slave has entered the CRC based ending procedure.

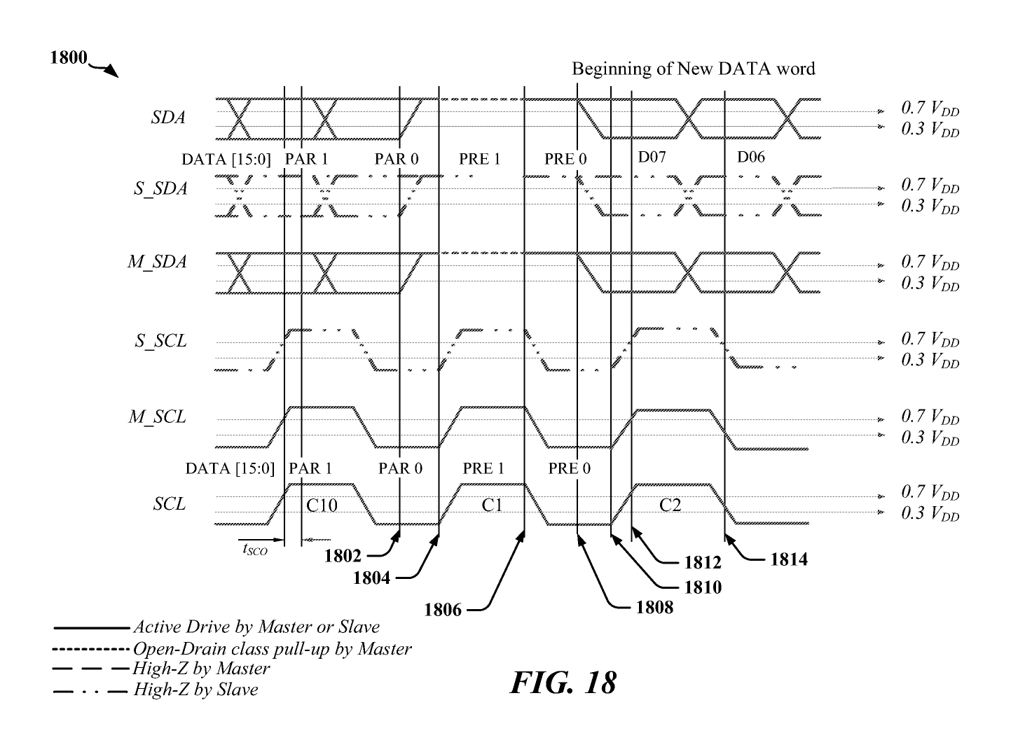

FIG. 18 illustrates another timeline 1800 for a scenario where a Slave agrees to continue WRITE data transfer. At time 1802, after the last parity bit, PAR 0, the Master drives the SDA line HIGH, for the next Preamble bit, PRE 1, which will be 1′b1. The Master starts the rising edge of C1, disables the active drive of SDA, and enables the Open-Drain class Pull-Up structure on SDA at time 1804. At time 1806, the Master starts the falling edge of C1. Since the Master knows that the SDA was left HIGH by the Slave, hence PRE 0 is 1′b1, the Master starts actively driving the SDA line HIGH.

At time 1808, after a suitable delay, the Master starts actively driving SDA HIGH or LOW, as required for the first data payload bit, D0.7. A simple way to achieve the delay is too use a half of an SCL cycle. At time 1810, the Master starts the rising edge of SCL C2. The Slave has both SCL and SDA released on High-Z. Next at times 1812 and 1814, respectively, the Slave registers D0.7 and D0.6. Consequently, the data transfer from Master to Slave continues.

Examples of Processing Circuits and Methods

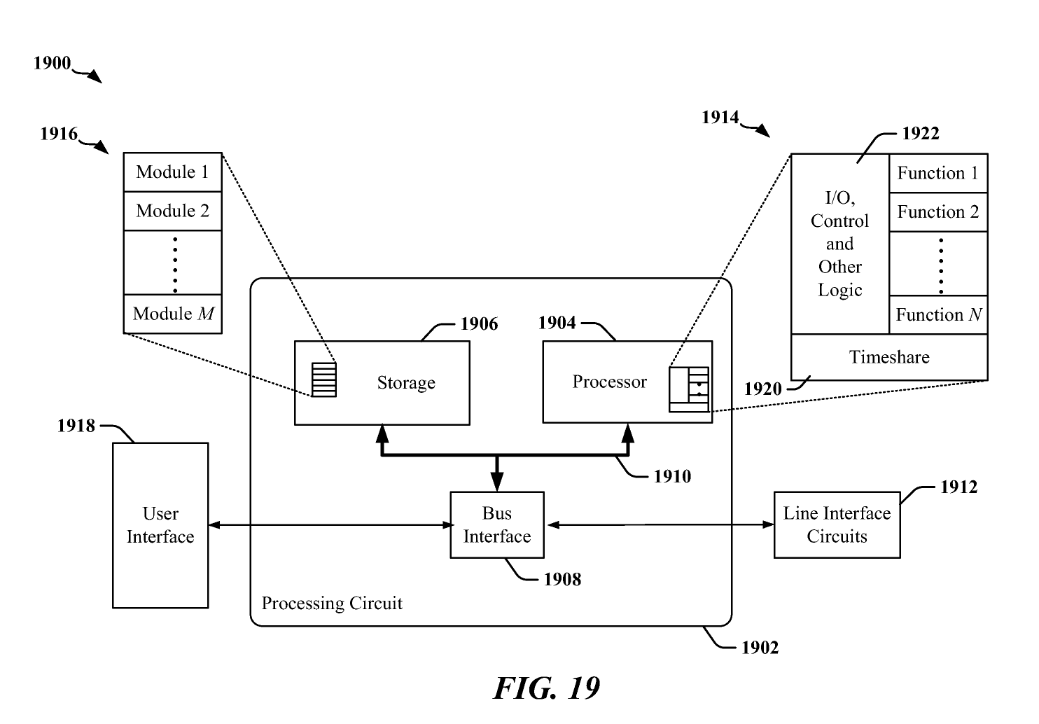

FIG. 19 is a diagram illustrating an example of a hardware implementation for an apparatus 1900 employing a processing circuit 1902 that may be configured to perform one or more functions disclosed herein. In accordance with various aspects of the disclosure, an element, or any portion of an element, or any combination of elements as disclosed herein may be implemented using the processing circuit 1902. The processing circuit 1902 may include one or more processors 1904 that are controlled by some combination of hardware and software modules. Examples of processors 1904 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1904 may include specialized processors that perform specific functions, and that may be configured, augmented or controlled by one of the software modules 1916. The one or more processors 1904 may be configured through a combination of software modules 1916 loaded during initialization, and further configured by loading or unloading one or more software modules 1916 during operation. In various examples, the processing circuit 1902 may be implemented using a state machine, sequencer, signal processor and/or general-purpose processor, or a combination of such devices and circuits.

In the illustrated example, the processing circuit 1902 may be implemented with a bus architecture, represented generally by the bus 1910. The bus 1910 may include any number of interconnecting buses and bridges depending on the specific application of the processing circuit 1902 and the overall design constraints. The bus 1910 links together various circuits including the one or more processors 1904, and storage 1906. Storage 1906 may include memory devices and mass storage devices, and may be referred to herein as computer-readable media and/or processor-readable media. The bus 1910 may also link various other circuits such as timing sources, timers, peripherals, voltage regulators, and power management circuits. A bus interface 1908 may provide an interface between the bus 1910 and one or more line interface circuits or transceivers 1912. Transceiver 1912 may be provided for each networking technology supported by the processing circuit. In some instances, multiple networking technologies may share some or all of the circuitry or processing modules found in a transceiver 1912. Each transceiver 1912 provides a means for communicating with various other apparatus over a transmission medium. Depending upon the nature of the apparatus 1900, a user interface 1918 (e.g., keypad, display, speaker, microphone, joystick) may also be provided, and may be communicatively coupled to the bus 1910 directly or through the bus interface 1908.

A processor 1904 may be responsible for managing the bus 1910 and for general processing that may include the execution of software stored in a computer-readable medium that may include the storage 1906. In this respect, the processing circuit 1902, including the processor 1904, may be used to implement any of the methods, functions and techniques disclosed herein. The storage 1906 may be used for storing data that is manipulated by the processor 1904 when executing software, and the software may be configured to implement any one of the methods disclosed herein.

One or more processors 1904 in the processing circuit 1902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1906 or in an external computer-readable medium. The external computer-readable medium and/or storage 1906 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1906 may also include, by way of example, a carrier wave, a transmission line, and any other suitable medium for transmitting software and/or instructions that may be accessed and read by a computer. Computer-readable medium and/or the storage 1906 may reside in the processing circuit 1902, in the processor 1904, external to the processing circuit 1902, or be distributed across multiple entities including the processing circuit 1902. The computer-readable medium and/or storage 1906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1906 may maintain software maintained and/or organized in loadable code segments, modules, applications, programs, etc., which may be referred to herein as software modules 1916. Each of the software modules 1916 may include instructions and data that, when installed or loaded on the processing circuit 1902 and executed by the one or more processors 1904, contribute to a run-time image 1914 that controls the operation of the one or more processors 1904. When executed, certain instructions may cause the processing circuit 1902 to perform functions in accordance with certain methods, algorithms and processes described herein.

Some of the software modules 1916 may be loaded during initialization of the processing circuit 1902, and these software modules 1916 may configure the processing circuit 1902 to enable performance of the various functions disclosed herein. For example, some software modules 1916 may configure internal devices and/or logic circuits 1922 of the processor 1904, and may manage access to external devices such as the transceiver 1912, the bus interface 1908, the user interface 1918, timers, mathematical coprocessors, and so on. The software modules 1916 may include a control program and/or an operating system that interacts with interrupt handlers and device drivers, and that controls access to various resources provided by the processing circuit 1902. The resources may include memory, processing time, access to the transceiver 1912, the user interface 1918, and so on.

One or more processors 1904 of the processing circuit 1902 may be multifunctional, whereby some of the software modules 1916 are loaded and configured to perform different functions or different instances of the same function. The one or more processors 1904 may additionally be adapted to manage background tasks initiated in response to inputs from the user interface 1918, the transceiver 1912, and device drivers, for example. To support the performance of multiple functions, the one or more processors 1904 may be configured to provide a multitasking environment, whereby each of a plurality of functions is implemented as a set of tasks serviced by the one or more processors 1904 as needed or desired. In one example, the multitasking environment may be implemented using a timesharing program 1920 that passes control of a processor 1904 between different tasks, whereby each task returns control of the one or more processors 1904 to the timesharing program 1920 upon completion of any outstanding operations and/or in response to an input such as an interrupt. When a task has control of the one or more processors 1904, the processing circuit is effectively specialized for the purposes addressed by the function associated with the controlling task. The timesharing program 1920 may include an operating system, a main loop that transfers control on a round-robin basis, a function that allocates control of the one or more processors 1904 in accordance with a prioritization of the functions, and/or an interrupt driven main loop that responds to external events by providing control of the one or more processors 1904 to a handling function.

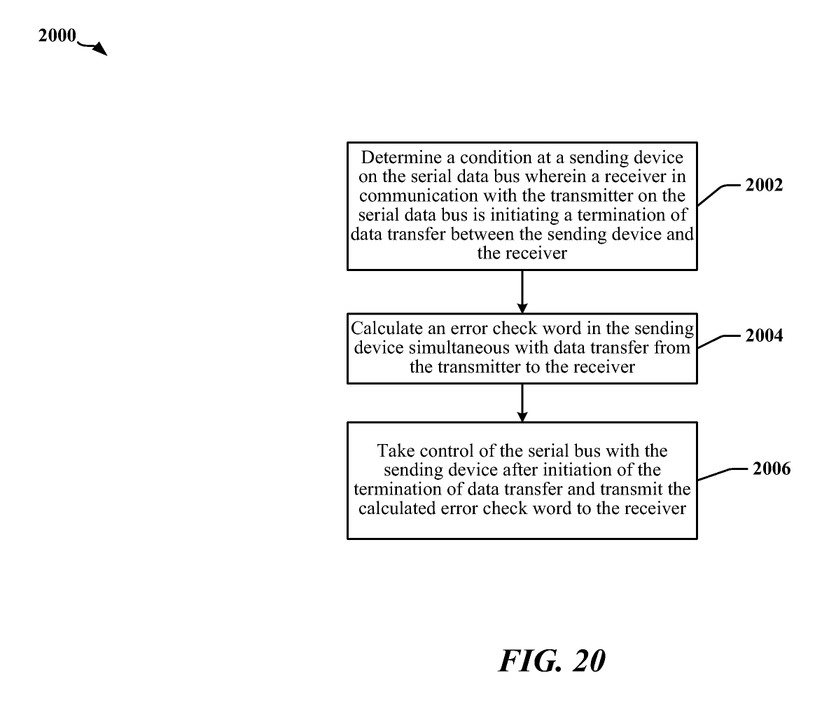

FIG. 20 is a flowchart 2000 illustrating a flow-control process that may be performed at a sending or transmitting device coupled to a serial data bus or multi-wire serial bus.

At block 2002, the sending or transmitter device on the serial data bus may determine a condition at such device whereby a receiver in communication with the transmitter on the serial data bus is initiating a termination of data transfer between the sending device and the receiver. In one I3C example, the serial bus may be configured for an HDR-DDR mode of operation.

At block 2004, the sending device may calculate an error check word (e.g., a CRC′ check word) in the sending device simultaneous with data transfer from the sending device to the receiver. Further, at block 2006, the sending device may temporarily take control of the serial bus with the transmitter after initiation of the termination of data transfer and transmit the calculated error check word to the receiver. The temporal aspect of taking control may be tied to a length of the CRC′ word, and the time period may be equal to the transmission time needed to transmit the single CRC′ word.

In one example, the sending device is a master device, but is not limited to such and may be a slave device in some aspects. In another example, transmitting the data over the serial bus includes transmitting a bit of data on each edge of a pulse of a clock signal transmitted on a second wire of the serial bus (e.g., SCL line). In various examples, the serial bus is operated in accordance with an I3C protocol, and HDR-DDR mode in particular. Terminating the data transmission may include transmitting an HDR exit pattern or HDR restart pattern on the serial bus.

In further aspects, method 2000 may further include the sending device giving up, relinquishing, or ceding control of the serial bus after the temporal transmitting of the calculated error check word to the receiver. In further aspects, the error check word is configured to avoid contention on the bus with a preamble from the receiver initiating the termination of data transfer. In yet a further aspect, the error check word configured to avoid contention on the bus includes setting at least of first bit of the error check word to a predetermined value to avoid contention.

In yet further aspects, the error check word is calculated in the sending device simultaneous with data transfer from the sending device to the receiver and includes iteratively calculating the error check word with one of each bit or two bits sent by the sending device on the serial data bus.

In still further aspects, method 2000 may include that the temporary taking control of the serial data bus with the sending device includes taking control within a duration of one serial bus clock cycle. In other examples, method 2000 may include that the serial data bus is operated in accordance with a high data rate (HDR) double data rate mode of operation of an I3C protocol, and that terminating data transmission over the serial data bus comprises transmitting an HDR restart pattern on the serial data bus. In yet a further aspect, the error check word comprises a cyclic redundancy check (CRC) word.

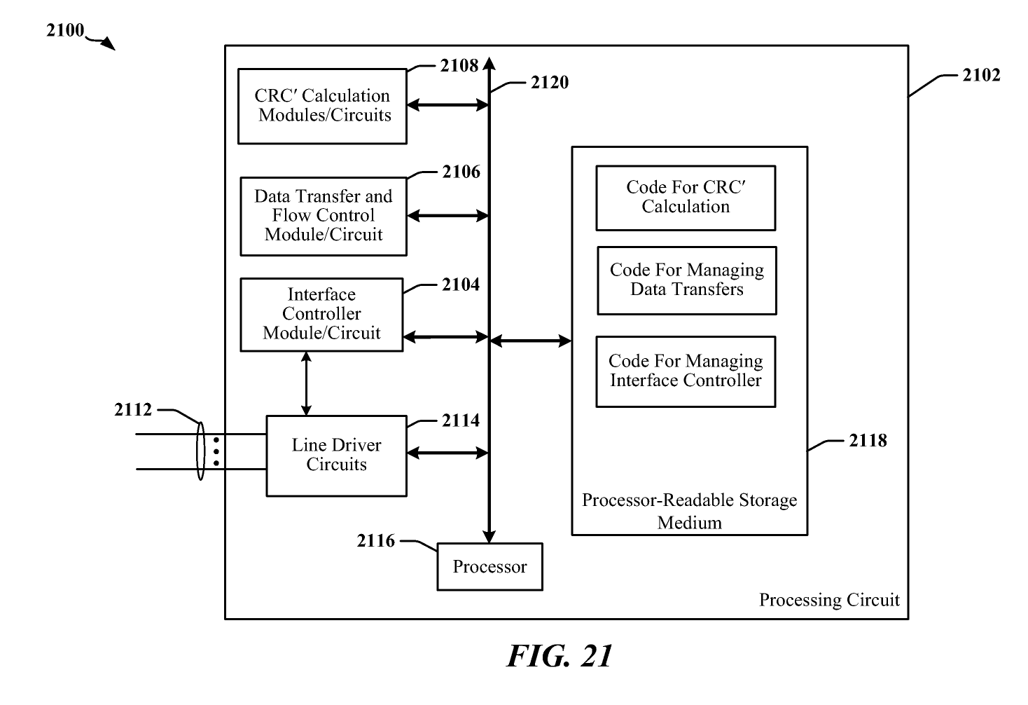

FIG. 21 is a diagram illustrating a simplified example of a hardware implementation for an apparatus 2100 employing a processing circuit 2102. The processing circuit typically has a controller or processor 2116 that may include one or more microprocessors, microcontrollers, digital signal processors, sequencers and/or state machines. The processing circuit 2102 may be implemented with a bus architecture, represented generally by the bus 2120. The bus 2120 may include any number of interconnecting buses and bridges depending on the specific application of the processing circuit 2102 and the overall design constraints. The bus 2120 links together various circuits including one or more processors and/or hardware modules, represented by the controller or processor 2116, the modules or circuits 2104, 2106 and 2108, and the computer-readable storage medium 2118. The apparatus may be coupled to a multi-wire communication link using a physical layer circuit 2114. The physical layer circuit 2114 may operate the multi-wire communication link 2112 to support communications in accordance with I3C protocols. The bus 2120 may also link various other circuits such as timing sources, peripherals, voltage regulators, and power management circuits, which are well known in the art, and therefore, will not be described any further.

The processor 2116 is responsible for general processing, including the execution of software, code and/or instructions stored on the computer-readable storage medium 2118. The computer-readable storage medium may include a non-transitory storage medium. The software, when executed by the processor 2116, causes the processing circuit 2102 to perform the various functions described supra for any particular apparatus. The computer-readable storage medium may be used for storing data that is manipulated by the processor 2116 when executing software. The processing circuit 2102 further includes at least one of the modules 2104, 2106 and 2108. The modules 2104, 2106 and 2108 may be software modules running in the processor 2116, resident/stored in the computer-readable storage medium 2118, one or more hardware modules coupled to the processor 2116, or some combination thereof. The modules 2104, 2106 and 2108 may include microcontroller instructions, state machine configuration parameters, or some combination thereof.

In one configuration, the apparatus 2100 includes an interface controller 2104, and line driver circuits 2114 including a first line driver coupled to a first wire of a multi-wire serial bus and a second line driver coupled to a second wire of the multi-wire serial bus 2112. The apparatus 2100 may include modules and/or circuits 2104, 2108, 2114 configured to transmit first data over the serial bus while the serial bus 2112 is configured for a DDR mode of operation. The apparatus may include modules and/or circuits 2104, 2106, 2114 configured to determine a condition whereby a receiver in communication with the transmitter on the serial data bus is initiating a termination or abort of data transfer between the transmitter and the receiver.

The apparatus 2100 may include modules and/or circuits 2104, 2108, 2114 configured to calculate an error check word (e.g., a CRC′ word) in the transmitter simultaneous with data transfer from the transmitter to the receiver. Further, apparatus 2100 may include modules and/or circuits 2104, 2106, 2108, and/or 2114 configured to the sending device may temporarily take control of the serial bus with the transmitter after initiation of the termination of data transfer and transmit the calculated error check word (e.g., CRC word) to the receiver.

In some examples, the apparatus is a master device and includes a pull-up circuit coupled to the first wire of the serial bus. The driver coupled to the first wire of the serial bus may be disabled by causing the first line driver to enter a high impedance state, and enabling the pull-up circuit. In one example, the interface controller 2104 is configured to transmit a bit of data on each edge of a pulse of a clock signal transmitted on a second wire of the serial bus 2112 in the DDR mode of operation. In one example, the serial bus 2112 is operated in accordance with an I3C protocol. The interface controller 2104 may be configured to transmit an HDR exit pattern or an HDR restart pattern on the serial bus 2112 when terminating data transmissions. Additionally, module 2108 may include a module for calculating the CRC′ word on the fly, and may be implemented by circuit 1002 in FIG. 10, as one example.

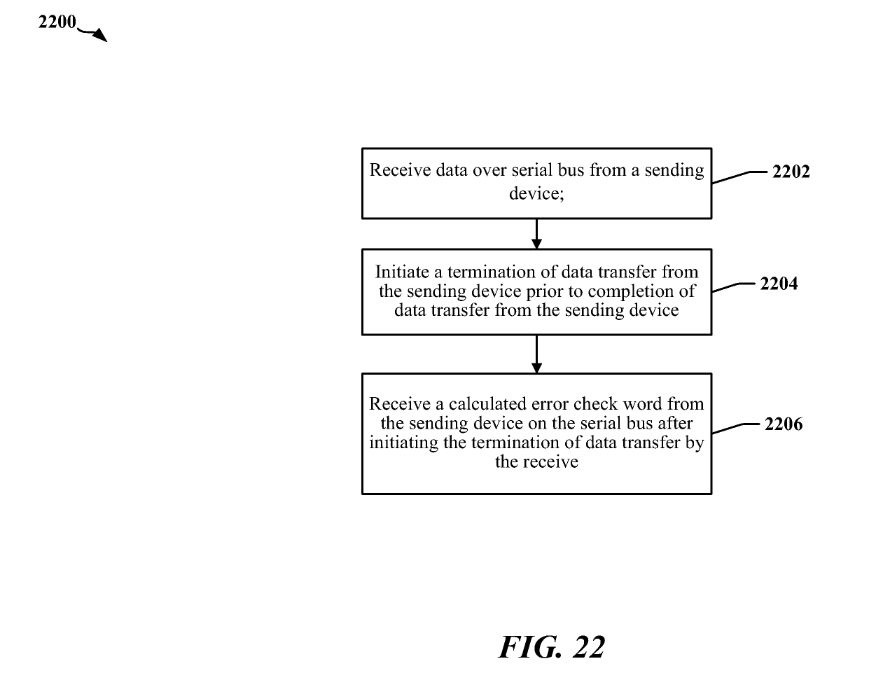

FIG. 22 is a flowchart 2200 illustrating a flow-control process that may be performed at a receiving device coupled to a serial bus. At block 2202, the receiving device may receive data over the serial bus from a sending device. In one example, the serial bus may be configured for an HDR-DDR mode of operation.

At block 2204, the receiving device may initiate a termination or abort of data transfer from the sending device prior to completion of data transfer from the sending device, such as in the case of a Master abort (See e.g., FIG. 7, the progression from state 704 to 708). At block 2206, the receiving device may receive a calculated error check word from the sending device on the serial bus after initiating the termination of data transfer by the receiver. In an aspect, the calculated error check word is a CRC′ word that has been calculated on the fly by the sender device.

In some examples, the serial bus is operated in accordance with an I3C protocol. The receiving device may receive an HDR exit pattern or an HDR restart pattern from the serial bus, wherein the HDR exit pattern and the HDR restart pattern are associated with a termination of a current data transmission over the serial bus.

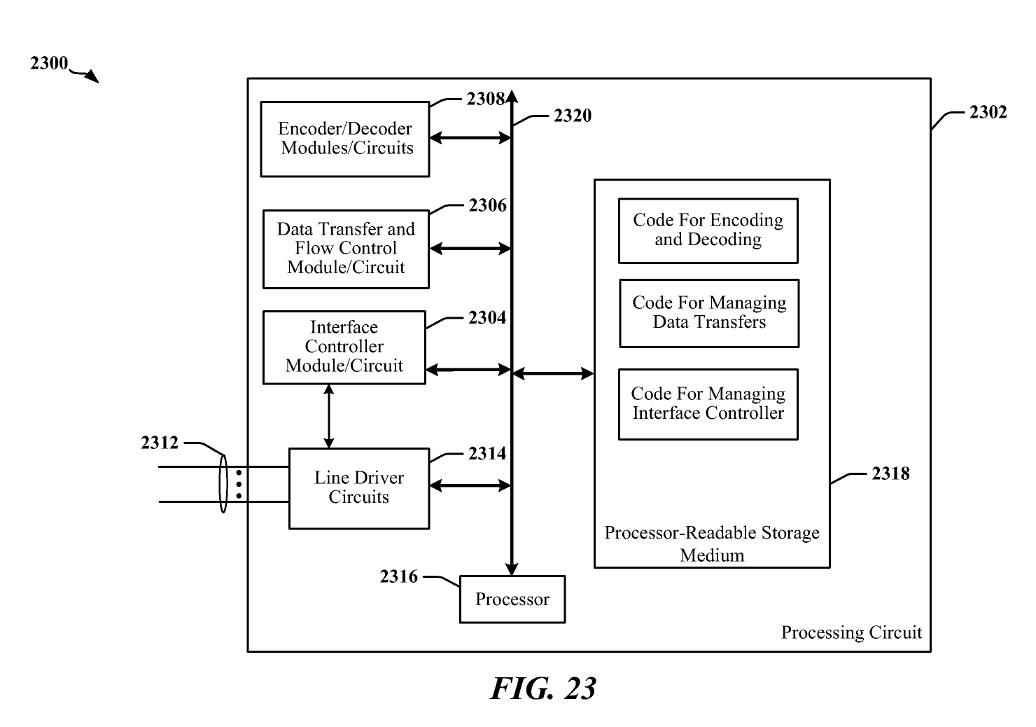

FIG. 23 is a diagram illustrating a simplified example of a hardware implementation for an apparatus 2300 employing a processing circuit 2302. The processing circuit typically has a controller or processor 2316 that may include one or more microprocessors, microcontrollers, digital signal processors, sequencers and/or state machines. The processing circuit 2302 may be implemented with a bus architecture, represented generally by the bus 2320. The bus 2320 may include any number of interconnecting buses and bridges depending on the specific application of the processing circuit 2302 and the overall design constraints. The bus 2320 links together various circuits including one or more processors and/or hardware modules, represented by the controller or processor 2316, the modules or circuits 2304, 2306 and 2308, and the computer-readable storage medium 2318. The apparatus may be coupled to a multi-wire communication link using a physical layer circuit 2314. The physical layer circuit 2314 may operate the multi-wire communication link 2312 to support communications in accordance with an I2C and/or I3C protocol. The bus 2320 may also link various other circuits such as timing sources, peripherals, voltage regulators, and power management circuits, which are well known in the art, and therefore, will not be described any further.

The processor 2316 is responsible for general processing, including the execution of software, code and/or instructions stored on the computer-readable storage medium 2318. The computer-readable storage medium may include a non-transitory storage medium. The software, when executed by the processor 2316, causes the processing circuit 2302 to perform the various functions described supra for any particular apparatus. The computer-readable storage medium may be used for storing data that is manipulated by the processor 2316 when executing software. The processing circuit 2302 further includes at least one of the modules 2304, 2306 and 2308. The modules 2304, 2306 and 2308 may be software modules running in the processor 2316, resident/stored in the computer-readable storage medium 2318, one or more hardware modules coupled to the processor 2316, or some combination thereof. The modules 2304, 2306 and 2308 may include microcontroller instructions, state machine configuration parameters, or some combination thereof.

In one configuration, the apparatus 2300 includes a first line driver coupled to a first wire of a multi-wire serial bus, a second line driver coupled to a second wire of the multi-wire serial bus. The apparatus 2300 may include modules and/or circuits 2304, 2306, 2314 configured to receive data over the serial bus from a sending device. In one example, the serial bus may be configured for an HDR-DDR mode of operation. The apparatus 2300 may include modules and/or circuits 2304, 2306, 2314 configured to initiate a termination or abort of data transfer from the sending device prior to completion of data transfer from the sending device, such as in the case of a Master abort (See e.g., FIG. 7, the progression from state 704 to 708). The apparatus 2300 may include modules and/or circuits 2304, 2306, 2314 configured to receive a calculated error check word from the sending device on the serial bus after initiating the termination of data transfer by the receive. In an aspect, the calculated error check word is a CRC word that has been calculated on the fly by the sender device.

In one example, the apparatus 2300 is a master device. In one example, the interface controller 2304 receives the first data over the serial bus 2312 using each edge of a pulse in a signal transmitted on a second wire of the serial bus 2312 to receive a bit of data. In various examples, the serial bus 2312 is operated in accordance with an I3C protocol. A HDR exit pattern or HDR restart pattern received from the serial bus 2312 may be associated with a termination of a current data transmission over the serial bus 2312.

In light of the foregoing, it will be appreciated by those skilled in the art that the presently disclosed methods, apparatus, and system provide for better utilization of the bus and, in particular, better utilization of data transferred prior to a receiver initiated abort or termination of data transfer. Thus, instead of dropping data from an aborted transfer (and re-transmitting the data later) due to higher risk of data corruption, transmission of a CRC′ word affords increased confidence for using already transferred data.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method for communication in a serial data bus, comprising:
determining at a sending device on the serial data bus a condition whereby a receiver in communication with the sending device over the serial data bus is initiating a termination of data transfer between the sending device and the receiver;
calculating an error check word in the sending device simultaneous with data transfer from the sending device to the receiver; and
taking control of the serial data bus with the sending device after initiation of the termination of data transfer and transmitting the calculated error check word from the sending device to the receiver.

2. The method of claim 1, further comprising:
relinquishing control of the serial data bus by the sending device after transmitting the calculated error check word to the receiver.

3. The method of claim 1, wherein the error check word is configured to avoid contention on the serial data bus with a preamble from the receiver initiating the termination of data transfer.

4. The method of claim 3, wherein configuring the error check word to avoid contention on the serial data bus includes setting at least a first bit of the error check word to a predetermined value to avoid contention.

5. The method of claim 1, wherein calculating the error check word in the sending device simultaneous with data transfer from the sending device to the receiver includes iteratively calculating the error check word with one of each bit or two bits sent by the sending device on the serial data bus.

6. The method of claim 1, wherein taking control of the serial data bus with the sending device includes taking control within a duration of one serial data bus clock cycle.

7. The method of claim 1, wherein the serial data bus is operated in accordance with a high data rate (HDR) double data rate mode of operation of an I3C protocol.

8. The method of claim 1, wherein terminating data transmission over the serial data bus comprises transmitting an HDR restart pattern on the serial data bus.

9. The method of claim 1, wherein the error check word comprises a cyclic redundancy check (CRC) word.

10. An apparatus, comprising:
a first line driver coupled to a first wire of a multi-wire serial bus;
a second line driver coupled to a second wire of the multi-wire serial bus; and
an interface controller configured to:
determine a condition whereby a receiver in communication with the apparatus on the multi-wire serial bus is initiating a termination of data transfer between the apparatus and the receiver;
calculate an error check word simultaneous with data transfer from the apparatus to the receiver; and
take control of the multi-wire serial bus with the apparatus after initiation of the termination of data transfer by the receiver and transmit the calculated error check word to the receiver.

11. The apparatus of claim 10, wherein the interface controller is further configured to:
relinquish control of the multi-wire serial bus after transmitting the calculated error check word to the receiver.

12. The apparatus of claim 10, wherein the error check word is configured to avoid contention on the multi-wire serial bus with a preamble from the receiver initiating the termination of data transfer.

13. The apparatus of claim 12, wherein configuring the error check word to avoid contention on the multi-wire serial bus includes setting at least a first bit of the error check word to a predetermined value to avoid contention.

14. The apparatus of claim 10, wherein calculating the error check word in the apparatus simultaneous with data transfer from the apparatus to the receiver includes iteratively calculating the error check word with one of each bit or two bits sent by the apparatus on the multi-wire serial bus.

15. The apparatus of claim 10, wherein taking control of the multi-wire serial bus with the apparatus includes taking control within a duration of one multi-wire serial bus clock cycle.

16. The apparatus of claim 10, wherein the multi-wire serial bus is operated in accordance with a high data rate (HDR) double data rate mode of operation of an I3C protocol.

17. The apparatus of claim 10, wherein terminating data transmission over the multi-wire serial bus comprises transmitting an HDR restart pattern on the multi-wire serial bus.

18. The apparatus of claim 10, wherein the error check word comprises a cyclic redundancy check (CRC) word.

19. An apparatus for communication in a serial data bus, comprising:
means for determining at a sending device on the serial data bus a condition whereby a receiver in communication with the sending device on the serial data bus is initiating a termination of data transfer between the sending device and the receiver;
means for calculating an error check word in the sending device simultaneous with data transfer from the sending device to the receiver; and
means for taking control of the serial data bus with the sending device after initiation of the termination of data transfer and transmitting the calculated error check word to the receiver.

20. The apparatus of claim 19, further comprising:
means for relinquishing control of the serial data bus by the sending device after transmitting the calculated error check word to the receiver.

21. The apparatus of claim 19, wherein the error check word is configured to avoid contention on the serial data bus with a preamble from the receiver initiating the termination of data transfer.

22. The apparatus of claim 21, wherein configuring the error check word to avoid contention on the serial data bus includes setting at least a first bit of the error check word to a predetermined value to avoid contention.

23. The apparatus of claim 19, wherein calculating the error check word in the sending device simultaneous with data transfer from the sending device to the receiver includes iteratively calculating the error check word with one of each bit or two bits sent by the sending device on the serial data bus.

24. The apparatus of claim 19, wherein taking control of the serial data bus with the sending device includes taking control within a duration of one serial data bus clock cycle.

25. The apparatus of claim 19, wherein the serial data bus is operated in accordance with a high data rate (HDR) double data rate mode of operation of an I3C protocol.

26. The apparatus of claim 19, wherein terminating data transmission over the serial data bus comprises transmitting an HDR restart pattern on the serial data bus.

27. The apparatus of claim 19, wherein the error check word comprises a cyclic redundancy check (CRC) word.

28. A method for communication of data over a serial bus, the method comprising:
receiving data at a receiving device over the serial bus from a sending device;
initiating a termination of data transfer from the sending device prior to completion of data transfer from the sending device; and
receiving a calculated error check word from the sending device on the serial bus after initiating the termination of data transfer by the receiver.

29. The method of claim 28, wherein the receiving device comprises a master device controlling a clock line of the serial bus.

30. The method of claim 28, wherein the error check word comprises a cyclic redundancy check (CRC) word that is calculated by the sending device contemporaneously with transmission of the data by the sending device.
